(19) United States
(12) Patent Application Publication
(10) Pub. No.: US 2024/0362547 A1
(43) Pub. Date: Oct. 31, 2024

(54) OPERATION PLAN CREATION DEVICE, OPERATION PLAN CREATION METHOD, OPERATION PLAN CREATION PROGRAM, AND METHOD FOR PRODUCING HYDROGEN

(71) Applicant: IHI Corporation, Tokyo (JP)

(72) Inventors: Yuji KOGUMA, Tokyo (JP); Kenichi HAMAGUCHI, Tokyo (JP); Akinobu INAMURA, Tokyo (JP); Sho KAZIKURA, Tokyo (JP)

(73) Assignee: IHI Corporation, Tokyo (JP)

(21) Appl. No.: 18/635,163

(22) Filed: Apr. 15, 2024

(30) Foreign Application Priority Data
Apr. 18, 2023 (JP) 2023-067989

(51) Int. Cl. G06Q 10/04; G06Q 10/0631; G06Q 50/06

(52) U.S. Cl. CPC G06Q 10/04; G06Q 10/06315; G06Q 50/06

(57) ABSTRACT

An operation plan creation device includes: a predicted value designation unit designating a predicted value of power to be supplied as first power from a first energy source to a power system; a constraint condition designation unit designating a constraint condition that includes a term indicating the first power and a term indicating second power and separately treats the first power and the second power for an operation of the power system; an objective function designation unit designating an objective function formulating an objective required for the power system; and an optimization calculation unit solving a problem defined by the predicted value of the power to be supplied, the constraint condition, and the objective function to obtain an operation plan for the power system.

### CROSS REFERENCE TO RELATED APPLICATIONS

This application claims the benefit of priority from Japanese Patent Application No. 2023-067989, filed on Apr. 18, 2023, the entire contents of which are incorporated herein by reference.

### BACKGROUND

The present disclosure describes an operation plan creation device, an operation plan creation method, an operation plan creation program, and a method for producing hydrogen. A microgrid includes an element supplying energy and an element consuming energy. An example of the element supplying energy is an energy source of renewable energy. Another example of the element supplying energy is an energy source of non-renewable energy. An example of an element that consumes energy to obtain a product is a water electrolysis device. In some cases, hydrogen produced by the water electrolysis device is used in place of fossil fuels in a gas turbine power generation device or the like installed in the same site as the water electrolysis device. In some cases, the hydrogen produced by the water electrolysis device is used in place of fossil fuels in a gas turbine power generation device or the like installed at a location away from the water electrolysis device.

The purpose of using hydrogen is to reduce CO₂ emissions caused by the use of fossil fuels. In this sense, the hydrogen produced by the water electrolysis device is required to be derived from renewable energy. Hydrogen not involving CO₂ emissions, that is, hydrogen derived from renewable energy or nuclear energy, is called “green hydrogen”. In some cases, hydrogen that is not derived from renewable energy or nuclear energy, but is derived from fossil fuels, is called “black hydrogen”.

Japanese Unexamined Patent Publication No. 2022-94118, Japanese Unexamined Patent Publication No. 2022-170429, Japanese Unexamined Patent Publication No. 2021-108536, and Japanese Unexamined Patent Publication No. 2022-176535 disclose technologies related to the operation of a microgrid configured by combining renewable energy and a water electrolysis device.

Japanese Unexamined Patent Publication No. 2022-94118 provides a planning support device for an energy system including renewable energy and a hydrogen production device. Japanese Unexamined Patent Publication No. 2022-170429 provides a method for economically operating hydrogen production using surplus power in the entire energy system. Japanese Unexamined Patent Publication No. 2021-108536 provides a technique that can identify an energy supply source when energy from a plurality of energy supply sources is stored. Japanese Unexamined Patent Publication No. 2022-176535 provides a market trading system distinguishing between renewable energy and non-renewable energy. For example, paragraph 0043 of Japanese Unexamined Patent Publication No. 2022-176535 discloses charging and discharging a storage battery while distinguishing between renewable energy and non-renewable energy.

### Solution to Problem

According to an aspect of the present disclosure, there is provided an operation plan creation device applied to a power system consuming first power obtained from a first energy source and second power obtained from a second energy source different from the first energy source. The power system includes a power receiving device. The operation plan creation device includes: a predicted value designation unit designating a predicted value of power to be supplied as the first power from the first energy source to the power system; a constraint condition designation unit designating a constraint condition that includes a term indicating the first power and a term indicating the second power and separately treats the first power and the second power for an operation of the power system; an objective function designation unit designating an objective function formulating an objective required for the power system; and an optimization calculation unit solving a problem defined by the predicted value of the power to be supplied, the constraint condition, and the objective function to obtain an operation plan for the power system.

### BRIEF DESCRIPTION OF THE DRAWINGS

FIG. 1 is a diagram showing a microgrid to which an operation plan obtained by an operation plan creation device according to an embodiment is applied.

FIG. 2 is a diagram showing a functional configuration of the operation plan creation device.

FIG. 3 is a diagram showing an example of a hardware configuration of the operation plan creation device.

FIG. 4 is a flowchart showing an operation plan creation method executed by the operation plan creation device according to the embodiment.

FIG. 5A is a table showing the meaning of the definition (overall) of symbols for a supply and demand planning problem. FIG. 5B is a table showing the meaning of the definition (system) of symbols for the supply and demand planning problem. FIG. 5C is a table showing the meaning of the definition (power demand) of symbols for the supply and demand planning problem. FIG. 5D is a table showing the meaning of the definition (hydrogen demand) of symbols for the supply and demand planning problem. FIG. 5E is a table showing the meaning of the definition (solar power generation) of symbols for the supply and demand planning problem.

FIG. 6A is a table showing the meaning of the definition (storage battery) of symbols for the supply and demand planning problem. FIG. 6B is a table showing the meaning of the definition (water electrolysis device) of symbols for the supply and demand planning problem.

FIG. 7 is a diagram showing another example of the microgrid to which the operation plan obtained by the operation plan creation device according to the embodiment is applied.

FIG. 8 is a table showing a summary of a numerical example used in a calculation example.

FIG. 9 is a graph showing a change in a supply and demand balance of green power.

FIG. 10 is a graph showing a change in a supply and demand balance of black power.

FIG. 11 is a graph showing a change in the breakdown of the green power/the black power covering power demand.

FIG. 12 is a graph showing a change in charging and discharging power of the storage battery.

FIG. 13 is a graph showing a change in the remaining charge of the storage battery.

FIG. 14 is a diagram showing another example of a system to which the operation plan obtained by the operation plan creation device is applied.

### DETAILED DESCRIPTION

In some cases, power supplied to a power system exemplified by a microgrid includes power derived from renewable energy and power not derived from renewable energy. In order to refer to hydrogen produced by a water electrolysis device as “green hydrogen”, it is important which of the power derived from renewable energy and the power not derived from renewable energy is supplied to the water electrolysis device.

In the techniques disclosed in Japanese Unexamined Patent Publication No. 2022-94118 and Japanese Unexamined Patent Publication No. 2022-170429, whether or not the power used to produce hydrogen is renewable energy is not considered. When an operation of economically generating hydrogen is considered, it is undeniable that the contribution of power derived from fossil fuels is likely to be great. In a case where the proportion of the power derived from fossil fuels to the power used to generate hydrogen is high, it does not contribute to reducing CO₂ emissions. In addition, assuming an energy conversion process that generates power from fossil fuels, generates hydrogen using the power, and obtains power using the hydrogen, energy loss occurs during these conversion processes. As a result, there is a possibility that the final amount of CO₂ emitted per power generated will increase. Therefore, in a case where hydrogen is considered as a replacement for fossil fuels, only the mechanisms of economically generating hydrogen, such as the techniques disclosed in Japanese Unexamined Patent Publication No. 2022-94118 and Japanese Unexamined Patent Publication No. 2022-170429, are not sufficient.

The water electrolysis device is also required to produce a desired amount of hydrogen.

When the techniques disclosed in Japanese Unexamined Patent Publication No. 2021-108536 and Japanese Unexamined Patent Publication No. 2022-176535 are used, it is possible to distinguish between renewable energy and non-renewable energy and to selectively charge the storage battery. Furthermore, when the techniques disclosed in Japanese Unexamined Patent Publication No. 2021-108536 and Japanese Unexamined Patent Publication No. 2022-176535 are used, it is possible to distinguish between power, which is renewable energy, and power, which is non-renewable energy, and to selectively discharge the storage battery. Therefore, it is possible to computationally guarantee that the power used by the water electrolysis device is derived from renewable energy. However, as described in paragraphs 0002, 0004, and 0005 of Japanese Unexamined Patent Publication No. 2021-108536, the technique disclosed in Japanese Unexamined Patent Publication No. 2021-108536 is aimed at visualizing and identifying the flow of power. That is, the technique disclosed in Japanese Unexamined Patent Publication No. 2021-108536 does not optimize the operation plan in consideration of a time axis. In the technique disclosed in Japanese Unexamined Patent Publication No. 2022-176535, a specific method for charging and discharging the storage battery with power, which is renewable energy, and power, which is not renewable energy, is not described. Therefore, in a case where the techniques disclosed in Japanese Unexamined Patent Publication No. 2021-108536 and Japanese Unexamined Patent Publication No. 2022-176535 are applied to a power system including a water electrolysis device, a problem arises in that the production of the required amount of hydrogen is not achieved.

The present disclosure provides an operation plan creation device, an operation plan creation method, an operation plan creation program, and a method for producing hydrogen that create an operation plan capable of setting power to be provided to a power receiving device to a desired aspect and achieving an objective required for a power system.

According to an aspect of the present disclosure, there is provided an operation plan creation device applied to a power system consuming first power obtained from a first energy source and second power obtained from a second energy source different from the first energy source. The power system includes a power receiving device. The operation plan creation device includes: a predicted value designation unit designating a predicted value of power to be supplied as the first power from the first energy source to the power system; a constraint condition designation unit designating a constraint condition that includes a term indicating the first power and a term indicating the second power and separately treats the first power and the second power for an operation of the power system; an objective function designation unit designating an objective function formulating an objective required for the power system; and an optimization calculation unit solving a problem defined by the predicted value of the power to be supplied, the constraint condition, and the objective function to obtain an operation plan for the power system.

According to another aspect of the present disclosure, there is provided an operation plan creation method applied to a power system consuming first power obtained from a first energy source and second power obtained from a second energy source different from the first energy source. The power system includes a power receiving device. The operation plan creation method includes: designating a predicted value of power to be supplied as the first power from the first energy source to the power system; designating a constraint condition that includes a term indicating the first power and a term indicating the second power and separately treats the first power and the second power for an operation of the power system; designating an objective function formulating an objective required for the power system; and solving a problem defined by the predicted value of the power to be supplied, the constraint condition, and the objective function to obtain an operation plan for the power system.

According to still another aspect of the present disclosure, there is provided an operation plan creation program applied to a power system consuming first power obtained from a first energy source and second power obtained from a second energy source different from the first energy source. The power system includes a power receiving device. The operation plan creation program causes a computer to execute: designating a predicted value of power to be supplied as the first power from the first energy source to the power system; designating a constraint condition that includes a term indicating the first power and a term indicating the second power and separately treats the first power and the second power for an operation of the power system; designating an objective function formulating an objective required for the power system; and solving a problem defined by the predicted value of the power to be supplied, the constraint condition, and the objective function to obtain an operation plan for the power system.

In the operation plan creation device, the operation plan creation method, and the operation plan creation program, the constraint condition that includes the term indicating the first power and the term indicating the second power and separately treats the first power and the second power is designated for the operation of the power system. Then, the problem defined by the predicted value of the power to be supplied, the constraint condition, and the objective function formulating the objective required for the power system is solved. As a result, it is possible to obtain the operation plan that can set the power provided to the power receiving device to a desired aspect and achieve the objective required for the power system.

In the operation plan creation device, the constraint condition designation unit may designate a first constraint condition which is the constraint condition, and the first constraint condition may be that only the first power is set as the power to be supplied to the power receiving device. According to this configuration, an aspect in which only the first power is supplied to the power receiving device can be implemented as the aspect of the power provided to the power receiving device.

In the operation plan creation device, the constraint condition designation unit may designate a second constraint condition which is the constraint condition, and the second constraint condition may be that a proportion of the first power to a total amount of power supplied to the power receiving device is designated. According to this configuration, an aspect in which the first power is supplied at a desired proportion to the power receiving device can be implemented as the aspect of the power provided to the power receiving device.

In the operation plan creation device, the power receiving device may consume the first power, and the constraint condition designation unit may designate a proportion of an amount of consumption of the first power to a total amount of power consumed by the power receiving device or the amount of the first power consumed by the power receiving device. According to this configuration, it is possible to obtain an operation plan that sets the proportion of the amount of consumption of the first power or the amount of consumption of the first power to a desired value.

In the operation plan creation device, the power receiving device may consume the first power, and the objective function designation unit may set, as the objective function, a function including at least one of a proportion of an amount of consumption of the first power to a total amount of power consumed by the power receiving device or the amount of the first power consumed by the power receiving device. According to this configuration, it is possible to obtain an objective function that sets the proportion of the amount of consumption of the first power or the amount of consumption of the first power to a desired aspect.

In the operation plan creation device, the power receiving device may consume the first power, and, for a function including at least one of a proportion of an amount of consumption of the first power to a total amount of power consumed by the power receiving device or the amount of the first power consumed by the power receiving device, the optimization calculation unit may solve a problem of maximizing the proportion of the amount of consumption of the first power or the amount of consumption of the first power as an optimization problem. According to this configuration, it is possible to obtain an operation plan that maximizes the proportion of the amount of consumption of the first power or the amount of consumption of the first power.

In the operation plan creation device, the power receiving device may store the first power, and the constraint condition designation unit may designate a proportion of an amount of storage of the first power to a total amount of power stored in the power receiving device or the amount of the first power stored in the power receiving device. According to this configuration, it is possible to obtain an operation plan that sets the proportion of the amount of storage of the first power or the amount of storage of the first power to a desired value.

In the operation plan creation device, the power receiving device may store the first power, and the objective function designation unit may set, as the objective function, a function including at least one of a proportion of an amount of storage of the first power to a total amount of power stored in the power receiving device or the amount of the first power stored in the power receiving device. According to this configuration, it is possible to obtain an objective function setting the proportion of the amount of storage of the first power or the amount of storage of the first power to a desired aspect.

In the operation plan creation device, the power receiving device may store the first power, and, for a function including at least one of a proportion of an amount of storage of the first power to a total amount of power stored in the power receiving device or the amount of the first power stored in the power receiving device, the optimization calculation unit may solve a problem of maximizing the proportion of the amount of storage of the first power or the amount of storage of the first power as an optimization problem. According to this configuration, it is possible to obtain an operation plan maximizing the proportion of the amount of storage of the first power or the amount of storage of the first power.

In the operation plan creation device, the objective function designation unit may designate a first objective function which is the objective function, and the first objective function may set minimization of the second power obtained from the second energy source as the objective required for the power system in order to meet a power demand of the power system. According to this configuration, it is possible to obtain an operation plan minimizing the second power obtained from the second energy source in order to meet the power demand of the power system.

In the operation plan creation device, the objective function designation unit may designate a second objective function which is the objective function, and the second objective function may set maximization of a product output by the power receiving device as a result of receiving at least the first power as the objective required for the power system. According to this configuration, it is possible to obtain an operation plan maximizing the product output by the power receiving device.

In the operation plan creation device, the objective function designation unit may designate a third objective function which is the objective function, and the third objective function may set, as the objective, at least one of minimization of a cost of operating the power system, maximization of profits from the operation of the power system, and minimization of an amount of carbon dioxide emitted by the operation of the power system. According to this configuration, it is possible to obtain an operation plan achieving at least one of the minimization of the cost of operating the power system, the maximization of the profits from the operation of the power system, and the minimization of the amount of carbon dioxide emitted by the operation of the power system.

In the operation plan creation device, the objective function designation unit may set an amount of emission of carbon dioxide associated with generation of the first power using a first numerical expression and set an amount of emission of carbon dioxide associated with generation of the second power using a second numerical expression different from the first numerical expression. According to this configuration, it is also possible to obtain an operation plan that can achieve the objective required for the power system.

In the operation plan creation device, the first energy source may output the first power based on renewable energy. According to this configuration, the first power can be used as so-called green power.

In the operation plan creation device, the power system may include a water electrolysis device as the power receiving device. According to this configuration, the power system can produce hydrogen.

In the operation plan creation device, the power system may include a storage battery as the power receiving device. According to this configuration, the power system can have a function of storing power.

The operation plan creation device may further include an optimization result output unit generating display information for displaying the operation plan on the basis of the operation plan. The optimization result output unit may display the power supplied to the power receiving device in an aspect in which the first power and the second power are distinguishable. According to this configuration, the operation plan can be presented in an aspect in which the first power and the second power can be distinguished.

In the operation plan creation device, the first power may be power not involving emission of carbon dioxide during power generation. According to this configuration, the first power can be used as so-called green power.

In the operation plan creation device, the second power may be power involving emission of carbon dioxide during power generation. According to this configuration, the second power can be used as so-called black power.

According to yet another aspect of the present disclosure, there is provided a method for producing hydrogen using a hydrogen production system consuming first power obtained from a first energy source and second power obtained from a second energy source different from the first energy source. The hydrogen production system includes at least a hydrogen production unit obtaining hydrogen using the first power. The method includes: designating a predicted value of power to be supplied as the first power from the first energy source to the hydrogen production unit; designating a constraint condition that includes a term indicating the first power and a term indicating the second power and separately treats the first power and the second power for an operation of the hydrogen production unit; designating an objective function formulating an objective required for the hydrogen production unit; and solving a problem defined by the predicted value of the power to be supplied, the constraint condition, and the objective function to obtain an operation plan for the hydrogen production unit.

According to the method for producing hydrogen, it is possible to perform an operation on the basis of the operation plan that can set the power provided to the hydrogen production unit to a desired aspect and achieve the objective required for the hydrogen production system.

According to the present disclosure, it is possible to provide an operation plan creation device, an operation plan creation method, an operation plan creation program, and a method for producing hydrogen that create an operation plan capable of setting power to be provided to a power receiving device to a desired aspect and achieving an objective required for a power system.

Hereinafter, embodiments of the present disclosure will be described in detail with reference to the accompanying drawings. In the description of the drawings, the same elements are denoted by the same reference numerals, and a description thereof will not be repeated.

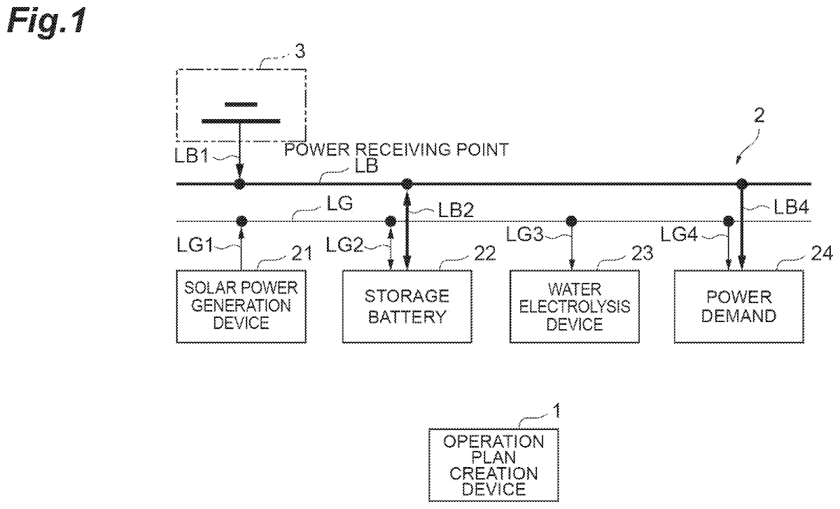

FIG. 1 shows an example of a configuration of a microgrid 2 (a power system or a hydrogen production system). The microgrid 2 is connected to an external system 3. The microgrid 2 includes a solar power generation device 21 (first energy source), a storage battery 22 (power receiving device), a water electrolysis device 23 (a power receiving device or a hydrogen production device), and a power demand 24. That is, the microgrid 2 is a hydrogen production system that can produce hydrogen.

In FIG. 1, a flow of power is divided into green power (first power) and black power (second power). The green power does not involve the emission of CO₂ during power generation. The black power involves the emission of CO₂.

The microgrid 2 includes a green power line LG for green power and a black power line LB for black power. Each of a green branch line LG1 connected to the solar power generation device 21, a green branch line LG2 connected to the storage battery 22, a green branch line LG3 connected to the water electrolysis device 23, and a green branch line LG4 connected to the power demand 24 is connected to the green power line LG. Each of a black branch line LB1 connected to the external system 3, a black branch line LB2 connected to the storage battery 22, and a black branch line LB4 connected to the power demand 24 is connected to the black power line LB.

A generation source of the green power is only the solar power generation device 21. Power received from the external system 3 (second energy source) is treated as the black power.

The storage battery 22 can be charged with both the green power and the black power. The storage battery 22 can discharge both the green power and the black power. Only the green power may be applied to the power demand 24. Only the black power may be applied to the power demand 24. Both the green power and the black power may be applied to the power demand 24. It is assumed that only the green power is applied to the water electrolysis device 23 generating hydrogen.

Optimization of an operation plan for the microgrid 2 means, first, satisfying a demand for power generated in the microgrid 2 in each time period. The optimization of the operation plan for the microgrid 2 means, second, minimizing the cost of receiving power while satisfying the constraint of producing a required amount of hydrogen throughout a planning period. The optimization of the operation plan for the microgrid 2 may be satisfied by achieving at least one of the first objective and the second objective.

In addition to the configuration shown in FIG. 1, there are many modification examples of the configuration of the microgrid 2. For example, the microgrid (like a remote island) may not be connected to the external system 3. Even in a case where the microgrid is not connected to the external system 3, when the received power is guaranteed to be the green power, the received power may be regarded as the green power. The received power may be a mixture of the green power and the black power at a predetermined ratio. For example, a non-fossil certificate corresponding to 20% of the total received power may be purchased such that the green power is 20% and the black power is 80%. In the optimization of the operation plan, the ratio between the green power and the black power may be determined. For example, the optimization of the operation plan may determine what percentage of the received power will be the green power.

A renewable energy generation device, such as a wind power generation device or a hydroelectric power generation device, may be applied instead of the solar power generation device 21. The renewable energy generation device may be a combination of the solar power generation device 21, the wind power generation device, and the hydroelectric power generation device. A geothermal power generation device, a biomass power generation device, and a generator consuming CO₂-free fuel to generate power (for example, a fuel cell) can also be given as examples of the supply source of the green power. The power generated by the generator may be set such that the green power and the black power are mixed at a predetermined ratio.

The external system 3 can be given as an example of the supply source of the black power. A device consuming fossil fuels, such as a gas turbine or a gas engine, can also be given as an example of the supply source of the black power.

In addition, power generated by a power source that does not actually achieve net zero emissions of CO₂ can be considered as green power by imposing a carbon tax on the power source. Whether or not CO₂ is actually emitted during power generation and the distinguishment between the green power and the black power do not need to be strictly equivalent to each other.

The type of the storage battery 22 is not particularly limited. Examples of the storage battery 22 include a lead-acid battery, which is a general secondary battery, a lithium-ion secondary battery, an all-solid-state battery, a nickel-hydrogen storage battery, a nickel-cadmium storage battery, a nickel-iron storage battery (Edison battery), a nickel-zinc storage battery, a silver oxide-zinc storage battery, and a cobalt titanium lithium secondary battery. Examples of a liquid-circulation-type secondary battery include a redox flow battery, a zinc-chlorine battery, and a zinc-bromine battery. Examples of a mechanical-charge-type secondary battery include an aluminum-air battery, a zinc-air battery, and an iron-air battery. Examples of a secondary battery for high-temperature operation include a sodium-sulfur battery (NAS battery) and a lithium-iron sulfide battery. A semiconductor secondary battery is given as an example of an electron-trap-type storage battery.

The storage battery (secondary battery) is a general term for a device that can charge and/or discharge power. It is assumed that the storage battery 22 also includes a PCS (power conditioning system) for converting a direct current of the storage battery 22 into an alternating current and a device for monitoring the remaining level of the storage battery 22. The storage battery 22 can also be replaced by an energy storage device having the same function, such as a condenser, a flywheel, a compressed air energy storage (CAES) facility, a pumped storage power generation facility, or a thermal storage power generation facility that temporarily stores electricity as heat and reconverts heat into electricity when needed.

There are variations in the flow of the green power and the black power. For example, the charging of the storage battery 22 with the black power may be prohibited. The application of the black power to the water electrolysis device 23 up to a predetermined percentage may be allowed.

The type of the water electrolysis device 23 is not particularly limited. The water electrolysis device 23 may be an alkaline water electrolysis device. The water electrolysis device 23 may be a polymer electrolyte membrane water electrolysis device.

The operational objective of the microgrid 2 can be selected from, for example, the minimization of the cost of receiving power, the maximization of the amount of hydrogen produced, the maximization of hydrogen production efficiency, the minimization of the cost of producing hydrogen, the minimization of the amount of power received, the maximization of an energy self-sufficiency rate, and the minimization of power curtailment.

### [Operation Plan Creation Device]

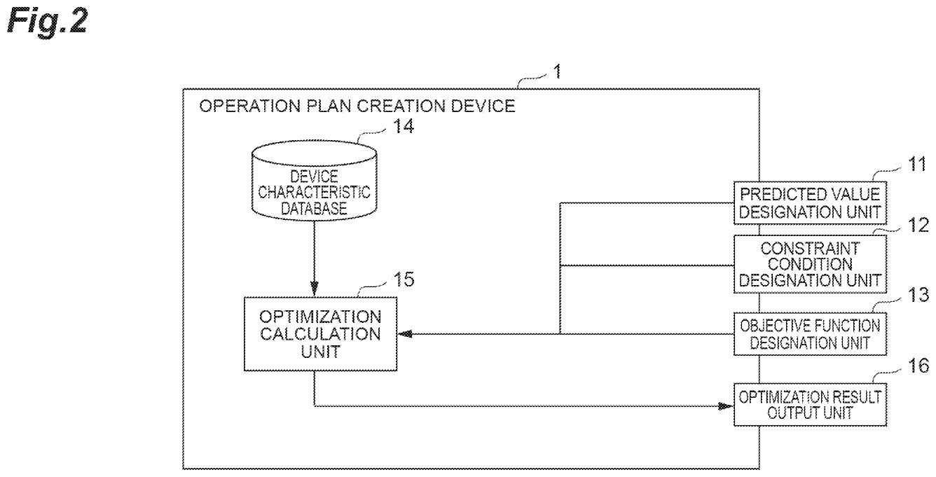

FIG. 2 shows an example of a configuration of an operation plan creation device 1 (operation plan creation unit). The operation plan creation device 1 calculates an optimal operation plan for an energy device (group) included in the microgrid 2. The operation plan output by the operation plan creation device 1 sets the power provided to the water electrolysis device 23 to a desired aspect to implement an aspect in which the green power is supplied to the water electrolysis device 23 and the black power is not supplied to the water electrolysis device 23. The operation plan output by the operation plan creation device 1 causes the microgrid 2 to execute a desired operation to implement an aspect in which the water electrolysis device 23 produces a desired amount of hydrogen.

The setting of the power provided to the water electrolysis device 23 to the desired aspect includes an aspect in which only the green power is supplied to the water electrolysis device 23. In the embodiment, the aspect in which only the green power is supplied to the water electrolysis device 23 will be described as an example. However, the present disclosure is not limited thereto. The setting also includes an aspect in which both the green power and the black power are supplied to the water electrolysis device 23. In the latter case, the setting includes an aspect in which the proportion of the green power to the power supplied to the water electrolysis device 23 is larger than a predetermined proportion. In other words, in the latter case, the setting includes an aspect in which the proportion of the black power to the power supplied to the water electrolysis device 23 is less than a predetermined proportion. These other examples will be described as modification examples as appropriate.

As shown in FIG. 2, the operation plan creation device 1 includes, as functional components, a predicted value designation unit 11, a constraint condition designation unit 12, an objective function designation unit 13, a device characteristic database 14, an optimization calculation unit 15, and an optimization result output unit 16.

The predicted value designation unit 11 can designate a predicted value of the power demand 24 or a predicted value of renewable energy generation power corresponding to each time period (for example, every 30 minutes) of the planning period (typically, the last one day, three days, seven days, or the like). In a case where a fluctuation in the power demand is small, the predicted value designation unit 11 may set any fixed value as the predicted value of the power demand 24. An example of any fixed value as the predicted value of the power demand 24 may be an average value for the past month. In a case where the fluctuation in the power demand is small as in geothermal power generation, the predicted value designation unit 11 may set any fixed value as the predicted value of renewable energy. The predicted value may be calculated by a statistical method or an artificial intelligence technique on the basis of weather forecast data or past result data. In a case where the power demand 24 can be planned in advance from, for example, the operation plan for power-using devices included in the microgrid 2, the planned value may be used as the predicted value.

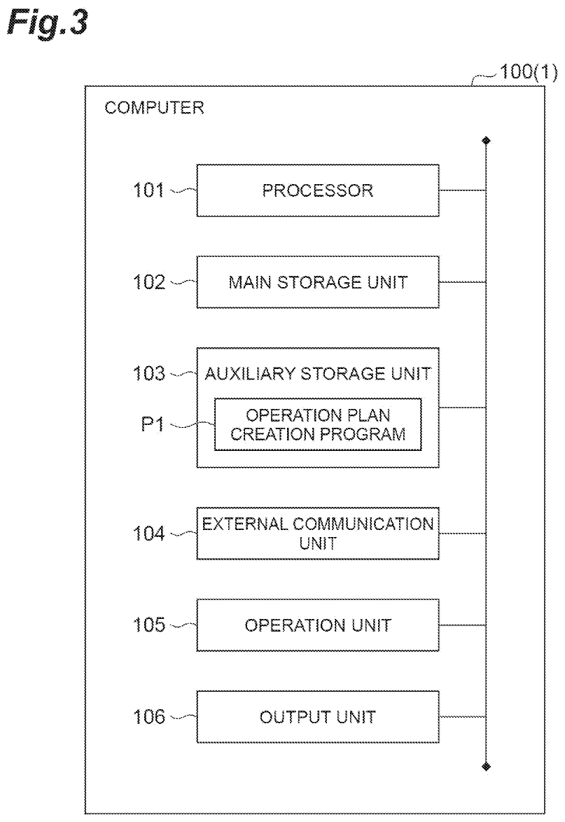

In this embodiment, the term “designation” includes input by the user of the operation plan creation device 1 using an input device, such as a keyboard, the reception of information by a computer 100 (FIG. 3) constituting the operation plan creation device 1 through a recording medium, a communication line or the like, and the further generation of information by the computer 100 using the information received by the computer 100.

The constraint condition designation unit 12 and the objective function designation unit 13 designate a constraint condition and an objective function in response to the reading of a file or an input operation of the user on the screen, respectively. The constraint condition designation unit 12 can designate, for example, the upper and lower limits of the power generated by each energy device or the upper and lower limits of the remaining charge of the storage battery 22. The objective function designation unit 13 can designate, for example, a power rate unit price to indirectly designate the objective function in optimization. The device characteristic database 14 stores a model of an energy device to be optimized and/or parameters of the energy device. The device characteristic database 14 stores, for example, a numerical expression related to efficiency and parameters of the numerical expression.

The optimization calculation unit 15 calculates a supply and demand plan that satisfies various constraint conditions and maximizes and/or minimizes a predetermined objective function on the basis of parameters given below as an example:
A predicted value designated by the predicted value designation unit 11;
A constraint condition designated by the constraint condition designation unit 12;
An objective function designated by the objective function designation unit 13; and
Energy device models and their parameters stored in the device characteristic database 14.

The supply and demand plan means the load distribution of each device to the energy demand at each time.

The optimization result output unit 16 outputs the supply and demand plan calculated by the optimization calculation unit 15 using an appropriate method such as a screen and/or a file.

The information designated by the “predicted value designation unit 11”, the “constraint condition designation unit 12”, and the “objective function designation unit 13” differs depending on the application target of the operation plan creation device 1 or its situation. For example, in a case where a generator is included as the energy device, the “constraint condition designation unit 12” may designate constraints related to starting and stopping or information related to an efficiency curve. The “objective function designation unit 13” may designate information of fuel costs. In the above-described embodiment, the power rate unit price is designated as a known value by the “objective function designation unit 13”. In a case where the power rate unit price changes depending on a supply and demand situation, the power rate unit price may be predicted by a prediction unit, and the prediction result may be used.

The operation plan creation device 1 is typically implemented by a single computer. However, there is flexibility in the form of the computer implementing the operation plan creation device 1. For example, each component of the operation plan creation device 1 may be implemented by a plurality of computers. The effects of the operation plan creation device 1 do not change depending on a difference in the configuration of the computer.

FIG. 2 is a diagram showing the function of the operation plan creation device 1. FIG. 2 shows only the function (operation plan creation function) intended by the operation plan creation device 1. In FIG. 2, the other functions, for example, a function of monitoring the state of the water electrolysis device 23 and the storage battery 22, an operation command function, a trend data storage function, and a demand monitoring function, are omitted. Communication between the operation plan creation device 1 and each device may be wired communication such as Ethernet (registered trademark). The communication between the operation plan creation device 1 and each device may be wireless communication. A communication protocol may be modbus/TCP or ECHONET Lite (registered trademark).

A hardware configuration of the operation plan creation device 1 will be described with reference to FIG. 3. The computer 100 includes a processor 101 which is a central processing unit (CPU), a main storage unit 102, an auxiliary storage unit 103, an external communication unit 104, an operation unit 105, and an output unit 106. The operation plan creation device 1 is configured by one or more computers 100 configured by these hardware components and software such as a program.

In a case where the operation plan creation device 1 is configured by a plurality of computers 100, the plurality of computers 100 may be locally connected to each other. The plurality of computers 100 may be connected to each other via a communication network such as the Internet or an intranet. The plurality of computers 100 are connected to each other to logically construct one operation plan creation device 1.

The processor 101 executes an operating system, application programs, and the like. The main storage unit 102 is configured by a read only memory (ROM) and a random access memory (RAM). The auxiliary storage unit 103, which is a storage medium, is configured by a hard disk, a flash memory, and the like. The auxiliary storage unit 103 generally stores a larger amount of data than the main storage unit 102. At least some of the units constituting the operation plan creation device 1 are implemented by the auxiliary storage unit 103. For example, the database shown in FIG. 2 may be implemented by the auxiliary storage unit 103. At least some of the units constituting the operation plan creation device 1 may be implemented by the external communication unit 104. The operation unit 105 is configured by a keyboard, a mouse, a touch panel, a voice input microphone, and the like. The output unit 106 is configured by a display, a printer, and the like. For example, the operation plan creation device 1 may display the operation plan and the like on the display and the like.

The auxiliary storage unit 103 stores in advance an operation plan creation program P1 and data necessary for processes. The operation plan creation program P1 causes the computer 100 to execute each functional element of the operation plan creation device 1. For example, the operation plan creation program P1 is read by the processor 101 or the main storage unit 102. The operation plan creation program P1 operates at least one of the processor 101, the main storage unit 102, the auxiliary storage unit 103, the external communication unit 104, the operation unit 105, and the output unit 106. For example, the operation plan creation program P1 reads and writes data from and to the main storage unit 102 and the auxiliary storage unit 103.

The operation plan creation program P1 may be recorded on a tangible recording medium or a non-transitory computer-readable medium, such as a CD-ROM, a DVD-ROM, or a semiconductor memory, and then provided. The operation plan creation program P1 may be provided as a data signal via the communication network.

### [Operation Plan Creation Method and Operation Plan Creation Program]

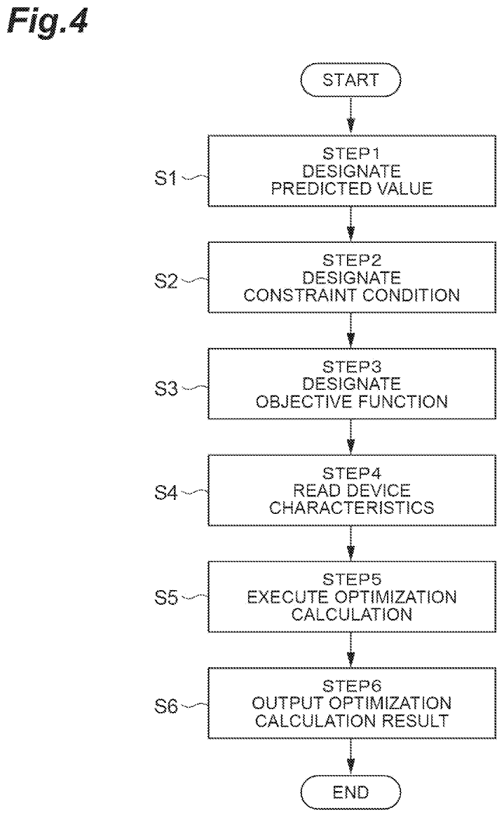

FIG. 4 shows an operating procedure of the operation plan creation device 1. Some or all of the operations in steps S1 to S6 shown in FIG. 4 are executed by the operation plan creation program P1 stored in the auxiliary storage unit 103 of the computer 100 shown in FIG. 3. The processor 101 of the computer 100 executes the operation plan creation program P1 to implement the functional configuration shown in FIG. 2.

The operation plan creation method includes an operation of designating a predicted value (step S1), an operation of designating a constraint condition (step S2), an operation of designating an objective function (step S3), an operation of reading device characteristics (step S4), an execution of optimization calculation (step S5), and an operation of outputting a result of the optimization calculation (step S6).

The operation of designating the predicted value (step S1) is executed by the predicted value designation unit 11. The operation of designating the constraint condition (step S2) is executed by the constraint condition designation unit 12. The operation of designating the objective function (step S3) is executed by the objective function designation unit 13. The operation of reading the device characteristics (step S4) is executed by the device characteristic database 14. The execution of the optimization calculation (step S5) is executed by the optimization calculation unit 15. The operation of outputting the result of the optimization calculation (step S6) is executed by the optimization result output unit 16. The specific operations in each step are as described in the description of the operation plan creation device 1.

The processes in steps S1 to S4 are independent of each other. That is, the processes in steps S1 to S4 are not necessarily executed in the order shown in FIG. 4. For example, the processes from step S1 to step S4 may be executed in the order of steps S1, S2, S3, and S4. The processes from step S1 to step S4 may be executed in the order of steps S4, S3, S2, and S1. The processes in steps S1 to S4 may be performed in parallel.

The operation plan obtained by the processes in steps S1, S2, S3, and S4 may be used as, for example, the next day's operation plan for the microgrid 2. The operation plan may be used as a revised plan for the current day. When the plan is revised each time using the latest predicted value, it is possible to perform an operation that is robust against an error in the prediction of power generated by solar power generation and/or power demand.

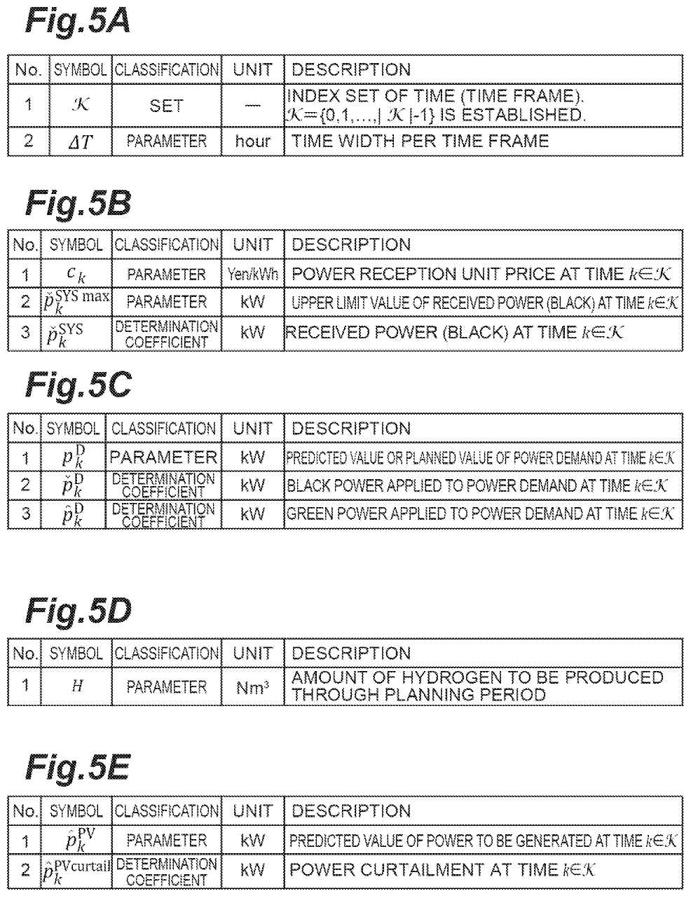

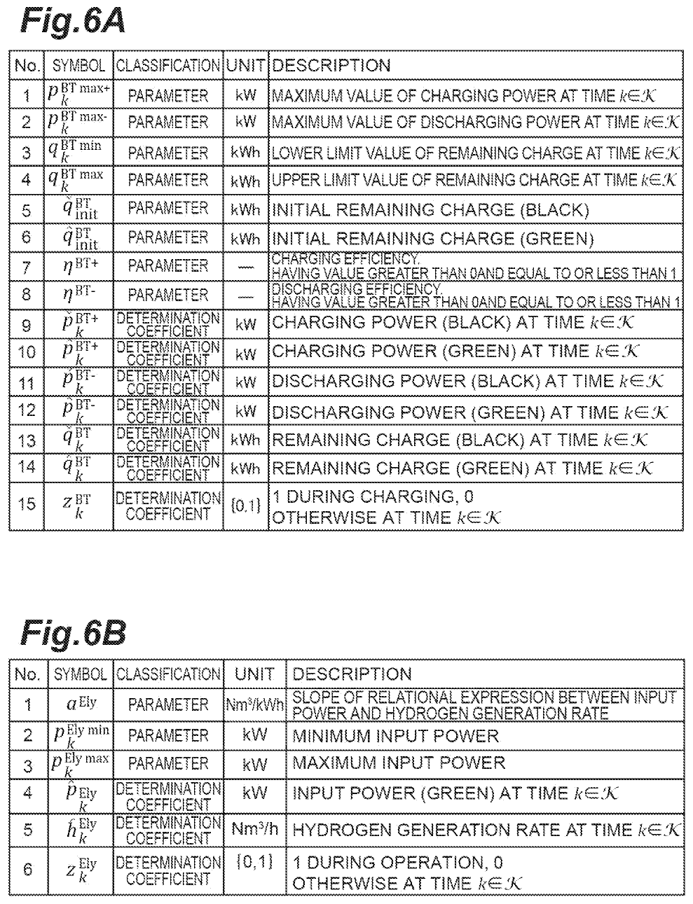

In the operation plan creation device 1, the formulation of the problem of the optimization executed in “step S5: the execution of optimization calculation” is devised to solve the problems of the related art. The definition of symbols used in the following description is shown in FIGS. 5A to 5E and FIGS. 6A and 6B.

When the breakdown of the green power and the black power is known, the initial remaining charge is set according to the breakdown. In a case where the breakdown is not known, for example, all power can be set as the back power to make a conservative evaluation.

The supply and demand planning problem is formulated as follows on the basis of the definitions of the symbols shown in tables of FIGS. 5A to 5E and FIGS. 6A and 6B.

### [Constraint Conditions]

Equations (1) and (2) relate to a supply and demand balance. Equation (1) defines that the demand for black power is matched with the supply of black power. Equation (2) defines that the demand for green power is matched with the supply of green power.

$$\begin{matrix}[ Expression 1 ] & \\ {\check{p}}_{k}^{BT +} + {\check{p}}_{k}^{D} = {\check{p}}_{k}^{BT -} + {\check{p}}_{k}^{SYS} ( k ∈ 𝒦 ) & ( 1 )\end{matrix}$$

$$\begin{matrix}[ Expression 2 ] & \\ {\hat{p}}_{k}^{BT +} + {\hat{p}}_{k}^{Ely} + {\hat{p}}_{k}^{D} + {\hat{p}}_{k}^{PV curtail} = {\hat{p}}_{k}^{PV} + {\hat{p}}_{k}^{BT -} ( k ∈ 𝒦 ) & ( 2 )\end{matrix}$$

Equation (3) relates to the external system 3. Equation (3) defines that only the reception of power from the external system 3 is possible. In other words, Equation (3) defines that power selling (reverse power flow) is not possible.

$$\begin{matrix}[ Expression 3 ] & \\ 0 \leq {\check{p}}_{k}^{SYS} \leq {\check{p}}_{k}^{SYS max} ( k ∈ 𝒦 ) & ( 3 )\end{matrix}$$

Equation (4) relates to the power demand 24. Equation (4) defines that the power demand is covered by the black power and the green power.

$$\begin{matrix}[ Expression 4 ] & \\ {\hat{p}}_{k}^{D} + {\check{p}}_{k}^{D} = {p}_{k}^{D} ( k ∈ 𝒦 ) & ( 4 )\end{matrix}$$

Equation (5) relates to hydrogen demand. Equation (5) defines that the hydrogen demand is covered by the hydrogen generated by the water electrolysis device 23.

$$\begin{matrix}[ Expression 5 ] & \\ {\sum }_{k ∈ 𝒦} Δ T {\hat{h}}_{k}^{Ely} = H & ( 5 )\end{matrix}$$

For the hydrogen demand, demand and supply are not necessarily matched with each other. For example, in a case where the supply of hydrogen exceeds the demand for hydrogen, a means of discarding hydrogen may be selected. In a case where the demand and supply of hydrogen do not need to be matched with each other, Equation (5) can be replaced with Equation (5A).

$$\begin{matrix}[ Expression 6 ] & \\ {\sum }_{k ∈ 𝒦} Δ T {\hat{h}}_{k}^{Ely} \geq H & ( 5 A )\end{matrix}$$

Equations (6) to (9) relate to the storage battery 22. Equations (6) to (9) define that charging and discharging are not capable of being performed at the same time. In addition, Equations (6) to (9) define that charging power and discharging power are not negative values and are equal to or less than a predetermined upper limit value.

$$\begin{matrix}[ Expression 7 ] & \\ 0 \leq {{p}^{⋁}}_{k}^{BT +} \leq {p}_{k}^{BT max +} {z}_{k}^{BT} ( k ∈ 𝒦 ) & ( 6 )\end{matrix}$$

$$\begin{matrix}[ Expression 8 ] & \\ 0 \leq {\hat{p}}_{k}^{BT +} \leq {p}_{k}^{BT max +} {z}_{k}^{BT} ( k ∈ 𝒦 ) & ( 7 )\end{matrix}$$

$$\begin{matrix}[ Expression 9 ] & \\ 0 \leq {{p}^{⋁}}_{k}^{BT -} \leq {p}_{k}^{BT max -} ( 1 - {z}_{k}^{BT} ) ( k ∈ 𝒦 ) & ( 8 )\end{matrix}$$

$$\begin{matrix}[ Expression 10 ] & \\ 0 \leq {\hat{p}}_{k}^{BT -} \leq {p}_{k}^{BT max -} ( 1 - {z}_{k}^{BT} ) ( k ∈ 𝒦 ) & ( 9 )\end{matrix}$$

Equations (10) and (11) relate to charging-discharging dynamics.

$$\begin{matrix}[ Expression 11 ] & \\ {\check{q}}_{k}^{B T} = \{ \begin{matrix}{{q}^{⋁}}_{k - 1}^{BT} + Δ T ( {η}^{BT +} {{p}^{⋁}}_{k}^{BT +} - \frac{1}{{η}^{BT -}} {{p}^{⋁}}_{k}^{BT -} ) ( k > 0 ) \\ {{q}^{⋁}}_{init}^{BT} + Δ T ( {η}^{BT +} {{p}^{⋁}}_{k}^{BT +} - \frac{1}{{η}^{BT -}} {{p}^{⋁}}_{k}^{BT -} ) ( k = 0 )\end{matrix} & ( 10 )\end{matrix}$$

$$\begin{matrix}[ Expression 12 ] & \\ {\hat{q}}_{k}^{BT} = \{ \begin{matrix}{\hat{q}}_{k - 1}^{BT} + Δ T ( {η}^{BT +} {\hat{p}}_{k}^{BT +} - \frac{1}{{η}^{BT -}} {\hat{p}}_{k}^{BT -} ) ( k > 0 ) \\ {\hat{q}}_{init}^{BT} + Δ T ( {η}^{BT +} {\hat{p}}_{k}^{BT +} - \frac{1}{{η}^{BT -}} {\hat{p}}_{k}^{BT -} ) ( k = 0 )\end{matrix} & ( 11 )\end{matrix}$$

Equation (12) relates to constraints on the upper and lower limits of the remaining charge.

$$\begin{matrix}[ Expression 13 ] & \\ {q}_{k}^{BT min} \leq {{q}^{⋁}}_{k}^{BT} + {\hat{q}}_{k}^{BT} \leq {q}_{k}^{BT max} ( k ∈ 𝒦 ) & ( 12 )\end{matrix}$$

Equations (13) and (14) relate to the water electrolysis device 23. Equation (13) defines a relationship between input power and a hydrogen generation rate. Equation (14) relates to input power during stopping and during starting.

$$\begin{matrix}[ Expression 14 ] & \\ {\hat{h}}_{k}^{Ely} = {a}^{Ely} {\hat{p}}_{k}^{Ely} ( k ∈ 𝒦 ) & ( 13 )\end{matrix}$$

$$\begin{matrix}[ Expression 15 ] & \\ {p}_{k}^{Ely min} {z}_{k}^{Ely} \leq {\hat{p}}_{k}^{Ely} \leq {p}_{k}^{Ely max} {z}_{k}^{Ely} ( k ∈ 𝒦 ) & ( 14 )\end{matrix}$$

### [Objective Function]

Equation (15) is an objective function. Equation (15) defines the minimization of the cost of receiving power.

$$\begin{matrix}[ Expression 16 ] & \\ f = {\sum }_{k ∈ 𝒦} Δ {Tc}_{k} {{p}^{⋁}}_{k}^{SYS} & ( 15 )\end{matrix}$$

The operation plan optimization problem of the microgrid 2 is defined as follows on the basis of the above definitions of the constraint conditions and the objective function.

[Expression 17]

(PG): minimize f (16)
subject to: Equations (1)-(14)

The optimization problem (PG) is solved to obtain the operation plan satisfying that the required power demand 24 is satisfied, that hydrogen is generated using only the green power, and that the cost of receiving power is minimized. The optimization problem (PG) belongs to a problem called a mixed integer programming problem. For the optimization problem (PG), an exact optimal solution can be found using a branch and bound method.

### Modification Examples of Constraint Conditions and Objective Function

There are many modification examples of the formulation of the optimization problem. The optimization problem may be modified depending on, for example, the configuration of facilities (type or number of facilities). For the optimization problem, the upper limit value of power received for each time period may be considered as various constraint conditions required for operation. For the optimization problem, the shortest and longest continuous operation times of the water electrolysis device 23 may be considered as various constraint conditions required for operation.

Variations, such as the minimization of costs, the maximization of the amount of hydrogen produced, the minimization of the amount of power received, and the minimization of CO₂ emissions, may be adopted as the objective function.

In a case where the amount of hydrogen produced is maximized, instead of excluding the equality constraint condition described by Equation (5), the left side of Equation (5) (the following equation) may be used as the objective function.

$${\sum }_{k ∈ 𝒦} Δ T {\hat{h}}_{k}^{Ely} \qquad [ Expression 18 ]$$

The objective function designated by the objective function designation unit 13 may define at least the maximization of the product output by the water electrolysis device 23 as a result of receiving the green power. According to this configuration, the maximization of the amount of hydrogen produced which is output by the water electrolysis device 23 can be set as the objective required for the microgrid 2.

In order to minimize the amount of power received, the following equation excluding the cost coefficient (cₖ) included in Equation (15) may be used as the objective function.

$$f = {\sum }_{k ∈ 𝒦} Δ T {{p}^{⋁}}_{k}^{SYS} \qquad [ Expression 19 ]$$

In order to minimize CO₂ emissions, the following equation obtained by changing the cost coefficient (cₖ) included in Equation (15) to an appropriate CO₂ emission coefficient (gₖ[t−CO₂·kWh]) may be used as the objective function.

$$f = {\sum }_{k ∈ 𝒦} Δ {Tg}_{k} {{p}^{⋁}}_{k}^{SYS} \qquad [ Expression 20 ]$$

In a case of a configuration including a generator, the objective function may include a term related to fuel costs. The objective function may be a function (weighted sum) obtained by weighting the plurality of objective functions described above and adding the weighted objective functions. In a case where the objective is to minimize CO₂ emissions for the configuration including the generator, a CO₂ emission coefficient applied to the generator and a CO₂ emission coefficient applied to the received power may be different from each other.

### Modification Example 1 Related to Constraints on Distinguishment Between Green Power and Black Power

The green power and the black power may be more strictly distinguished from each other. In this embodiment, it is assumed that the green power required by the water electrolysis device 23 may be supplied at the time when the water electrolysis device 23 is operated. In this embodiment, the power supplied to the microgrid 2 at a certain time is allowed to include both the green power and the black power. In contrast, the constraint that the total amount of power supplied to the water electrolysis device 23 and the power demand 24 of the microgrid 2 at the time when the water electrolysis device 23 is operated is the green power may be provided. In order to implement this constraint, variables of 0 and 1 shown in Equation (17) may be introduced. Specifically, the constraints shown in Equations (18) and (19) may be added to Equation (17).

$$\begin{matrix}[ Expression 21 ] & \\ {z}_{k}^{Green} = \{ \begin{matrix}1 , & \vert \begin{matrix}The entire amount of power supplied at a \\ time k is green power\end{matrix} \\ 0 , & otherwise\end{matrix} ( k ∈ 𝒦 ) & ( 17 )\end{matrix}$$

$$\begin{matrix}[ Expression 22 ] & \\ {\check{p}}_{k}^{D} \leq ( 1 - {z}_{k}^{Green} ) {p}_{k}^{D} ( k ∈ 𝒦 ) & ( 18 )\end{matrix}$$

$$\begin{matrix}[ Expression 23 ] & \\ {z}_{k}^{Green} \geq {z}_{k}^{Ely} & ( 19 )\end{matrix}$$

Equation (18) indicates that, in a case where the entire amount of power supplied is the green power (zₖ^{Green}=1), the application of the black power to the power demand 24 needs to be zero. Equation (19) indicates that the entire amount of power supplied at the time when the water electrolysis device 23 is started (zₖ^{Ely}=1) needs to be the green power (zₖ^{Green}=1).

The constraint condition designation unit 12 may designate a limiting constraint condition setting that the power supplied to the water electrolysis device 23 is only the green power. The limiting constraint condition includes a condition (Equation 18) that, in a case where all the power supplied to the microgrid 2 at a predetermined time is the green power, the microgrid 2 does not receive the black power from the external system 3 and a condition (Equation (19)) that the water electrolysis device 23 receives only the green power at the time when the water electrolysis device 23 is operated, which is included in the predetermined time. According to this configuration, an aspect in which only the green power is supplied to the water electrolysis device 23 can be implemented as the aspect of the power provided to the water electrolysis device 23.

### Modification Example 2 Related to Constraints on Distinguishment Between Green Power and Black Power

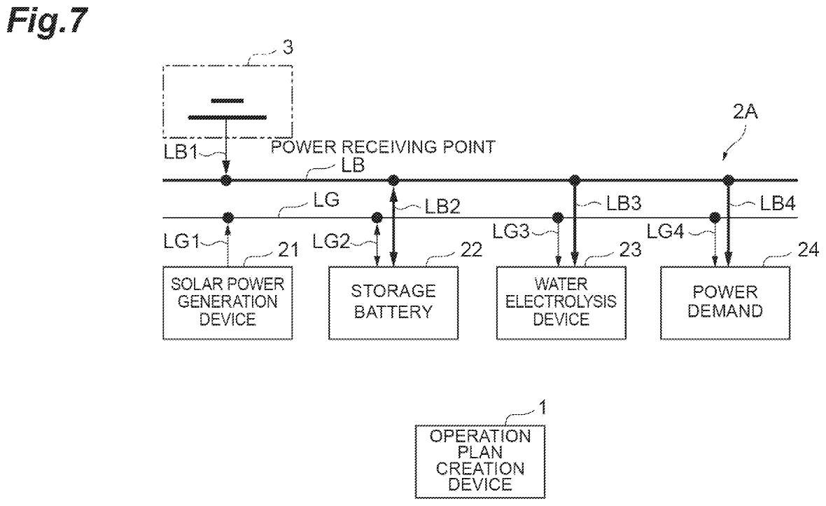

On the other hand, the constraints on the distinguishment between the green power and the black power may be slightly relaxed. For example, a constraint that the ratio of the green power or the amount of green power is set to be equal to or greater than a predetermined value while the use of the black power to generate hydrogen is allowed may be provided. The ratio of the green power may be maximized as the objective function. The amount of green power may be maximized as the objective function. When optimization is performed under this condition, it is possible to minimize the amount of CO₂ emitted per unit amount of hydrogen produced. In addition, the amount of CO₂ emitted per unit amount of hydrogen produced can be set to be equal to or less than a predetermined value. In this case, as shown in FIG. 7, a microgrid 2A further includes a black branch line LB3 for supplying the black power to the water electrolysis device 23. The equations related to the optimization problem represented by Equations (1) to (16) are modified as follows.

Equation (1) defining that the demand for black power is matched with the supply of black power is modified to Equation (20).

$$\begin{matrix}[ Expression 24 ] & \\ {\check{p}}_{k}^{BT +} + {\check{p}}_{k}^{Ely} + {\check{p}}_{k}^{D} = {\check{p}}_{k}^{BT -} + {\check{p}}_{k}^{SYS} ( k ∈ 𝒦 ) & ( 20 )\end{matrix}$$

Equation (5) defining that hydrogen demand is covered by the hydrogen generated by the water electrolysis device 23 is modified to Equation (21).

$$\begin{matrix}[ Expression 25 ] & \\ {\sum }_{k ∈ 𝒦} Δ T ( {\hat{h}}_{k}^{Ely} + {\check{h}}_{k}^{Ely} ) = H & ( 21 )\end{matrix}$$

Equation (13) defining the relationship between the input power of the water electrolysis device 23 and the hydrogen generation rate is modified to Equations (22) and (23).

$$\begin{matrix}[ Expression 26 ] & \\ {\hat{h}}_{k}^{Ely} = {a}^{Ely} {\hat{p}}_{k}^{Ely} ( k ∈ 𝒦 ) & ( 22 )\end{matrix}$$

$$\begin{matrix}[ Expression 27 ] & \\ {\check{h}}_{k}^{Ely} = {a}^{Ely} {\check{p}}_{k}^{Ely} ( k ∈ 𝒦 ) & ( 23 )\end{matrix}$$

Equation (14) defining the input power while the water electrolysis device 23 is stopped and started is modified to Equation (24).

$$\begin{matrix}[ Expression 28 ] & \\ {p}_{k}^{Ely min} {z}_{k}^{Ely} \leq {\hat{p}}_{k}^{Ely} + {\check{p}}_{k}^{Ely} \leq {p}_{k}^{Ely max} {z}_{k}^{Ely} ( k ∈ 𝒦 ) & ( 24 )\end{matrix}$$

In addition, the symbols included in Equations (20) to (24) have the following meanings.

TABLE 1

| | |
|---|---|
| \check{p}ₖ^{Ely} | Black power input to water |
| | electrolysis device |
| \check{h}ₖ^{Ely} | Black hydrogen generated by |
| | black power input to water |
| | electrolysis device |
| [symbol] ΔT\hat{p}ₖ^{Ely} | Green power used to generate |
| | hydrogen through planning period |
| [symbol] ΔT\check{p}ₖ^{Ely} | Black power used to generate |
| | hydrogen through planning period |
| [symbol] ΔTĥₖ^{Ely} | Amount of green hydrogen produced |
| [symbol] ΔT\check{h}ₖ^{Ely} | Amount of back hydrogen produced |

The above variations can be made by providing constraints on the variables shown in Table 1. The above variations can also be made by incorporating these constraints as the objective function. In addition to the constraints on the power used to generate hydrogen, the maximization of the power used to generate hydrogen, and the minimization of the power used to generate hydrogen, constraints on the amount of green hydrogen produced and the amount of black hydrogen produced may be considered. The maximization of the amount of green hydrogen produced and the minimization of the amount of black hydrogen produced may also be considered.

The constraint condition designation unit 12 may designate an allowable constraint condition for setting the green power and the black power as the power to be supplied to the water electrolysis device 23. According to this configuration, an aspect in which the green power and the black power are supplied to the water electrolysis device 23 can be implemented as the aspect of the power provided to the water electrolysis device 23.

For example, it is assumed that the power supplied to the microgrid 2 includes the green power and the black power and that the water electrolysis device 23 can be supplied with the green power and the black power. It is assumed that only the optimization of the amount of hydrogen produced is a constraint and an objective for creating the operation plan. In this case, the water electrolysis device 23 is supplied with the green power obtained by multiplying the total amount of power supplied to the microgrid 2 by a preset ratio and the black power obtained by multiplying the total amount of power supplied to the microgrid 2 by a preset ratio. For example, it is assumed that the ratio of the green power to the black power in the total amount of power supplied to the microgrid 2 is 5:5. In this case, the ratio of the green power to the black power supplied to the water electrolysis device 23 is also 5:5.

In contrast, as in this embodiment, the constraints related to the power supplied to the water electrolysis device 23 are applied, which makes it possible to independently set the ratio of the green power to the black power in the total amount of power supplied to the water electrolysis device 23 without being influenced by the ratio of the green power to the black power in the total amount of power supplied to the microgrid 2.

For example, the ratio of the green power to the black power in the total amount of power supplied to the microgrid 2 may be set to 5:5, and the ratio of the green power to the black power in the total amount of power supplied to the water electrolysis device 23 may be set to 9:1.

### Modification Examples Related to Other Constraints and Objective Functions

Constraints may also be provided on the power stored in the storage battery 22 such that the ratio of the green power or the amount of green power is equal to or greater than a predetermined value. The ratio of the green power or the amount of green power may be maximized as the objective function. The number of water electrolysis devices 23 or storage batteries 22 may be plural. The above-mentioned constraints and maximization may be considered for some water electrolysis devices 23 or storage batteries 22 among the plurality of water electrolysis devices 23 or storage batteries 22. The application of the formulation described so far makes it possible to easily formulate the optimization problem as the mixed integer programming problem.

The operation plan creation device 1 is applied to the microgrid 2 consuming the green power obtained from the solar power generation device 21 and the black power obtained from the external system 3 different from the solar power generation device 21. The microgrid 2 includes at least one of the water electrolysis device 23 and the storage battery 22. The operation plan creation device 1 includes the predicted value designation unit 11 designating a predicted value of power to be supplied as the green power from the solar power generation device 21 to the microgrid 2, the constraint condition designation unit 12 designating a constraint condition that includes a term indicating the green power and a term indicating the black power and separately treats the green power and the black power for the operation of the microgrid 2, the objective function designation unit 13 designating an objective function formulating an objective required for the microgrid 2, and the optimization calculation unit 15 solving a problem defined by the predicted value of the power to be supplied, the constraint condition, and the objective function to obtain an operation plan for the microgrid 2.

The operation plan creation method is applied to the microgrid 2 consuming the green power obtained from the solar power generation device 21 and the black power obtained from the external system 3 different from the solar power generation device 21. The microgrid 2 includes at least one of the water electrolysis device 23 and the storage battery 22. The operation plan creation method includes: designating a predicted value of power to be supplied as the green power from the solar power generation device 21 to the microgrid 2 (step S1); designating a constraint condition that includes a term indicating the green power and a term indicating the black power and separately treats the green power and the black power for the operation of the microgrid 2 (step S2); designating an objective function formulating an objective required for the microgrid 2 (step S3); and solving a problem defined by the predicted value of the power to be supplied, the constraint condition, and the objective function to obtain an operation plan for the microgrid 2 (step S5).

The operation plan creation program P1 is applied to the microgrid 2 consuming the green power obtained from the solar power generation device 21 and the black power obtained from the external system 3 different from the solar power generation device 21. The microgrid 2 includes at least one of the water electrolysis device 23 and the storage battery 22. The operation plan creation program P1 causes the computer 100 to execute: designating a predicted value of power to be supplied as the green power from the solar power generation device 21 to the microgrid 2; designating a constraint condition that includes a term indicating the green power and a term indicating the black power and separately treats the green power and the black power for the operation of the microgrid 2; designating an objective function formulating an objective required for the microgrid 2; and solving a problem defined by the predicted value of the power to be supplied, the constraint condition, and the objective function to obtain an operation plan for the microgrid 2.

The operation plan creation device 1, the operation plan creation method, and the operation plan creation program P1 are related to the operation of the microgrid 2. In the operation plan creation device 1, the operation plan creation method, and the operation plan creation program P1, the constraint condition that includes the term indicating the green power and the term indicating the black power and separately treats the green power and the black power is designated. Then, in the operation plan creation device 1, the operation plan creation method, and the operation plan creation program P1, the problem defined by the predicted value of the power to be supplied, the constraint condition, and the objective function formulating the objective required for the microgrid 2 is solved. As a result, it is possible to obtain an operation plan that can set the power provided to the water electrolysis device 23 to a desired aspect and achieve the objective required for the microgrid 2.

A method for producing hydrogen produces hydrogen using a hydrogen production system consuming the green power obtained from the solar power generation device 21 and the black power obtained from the external system 3 different from the solar power generation device 21. The hydrogen production system includes at least the water electrolysis device 23 obtaining the hydrogen using the green power. The method for producing hydrogen includes: designating a predicted value of power to be supplied as the green power from the solar power generation device 21 to the microgrid 2 (step S1); designating a constraint condition that includes a term indicating the green power and a term indicating the black power and separately treats the green power and the black power for the operation of the microgrid 2 (step S2); designating an objective function formulating an objective required for the microgrid 2 (step S3); and solving a problem defined by the predicted value of the power to be supplied, the constraint condition, and the objective function to obtain an operation plan for the microgrid 2 (step S5).

According to this method for producing hydrogen, it is possible to perform an operation on the basis of an operation plan that can set the power provided to at least one of the water electrolysis device 23 and the storage battery 22 to a desired aspect and achieve the objective required for the microgrid.

The constraint condition designation unit 12 designates a first constraint condition which is the constraint condition. The first constraint condition may be that only the green power is set as the power to be supplied to at least one of the water electrolysis device 23 and the storage battery 22. According to this configuration, an aspect in which only the green power is supplied to the water electrolysis device 23 can be implemented as the aspect of the power provided to the water electrolysis device 23.

The constraint condition designation unit 12 designates a second constraint condition which is the constraint condition. The second constraint condition may be that the proportion of the green power to the total amount of power supplied to at least one of the water electrolysis device 23 and the storage battery 22 is designated. According to this configuration, an aspect in which the green power is supplied at a desired proportion to the water electrolysis device 23 can be implemented as the aspect of the power provided to the water electrolysis device 23.

The water electrolysis device 23 consumes the green power. The constraint condition designation unit 12 may designate the proportion of the amount of consumption of the green power to the total amount of power consumed by the water electrolysis device 23 or the amount of green power consumed by the water electrolysis device 23. According to this configuration, it is possible to obtain an operation plan setting the proportion of the amount of consumption of the green power or the amount of consumption of the green power to a desired value.

The water electrolysis device 23 consumes the green power. The objective function designation unit 13 may set, as the objective function, a function including at least one of the proportion of the amount of consumption of the green power to the total amount of power consumed by the water electrolysis device 23 or the amount of green power consumed by the water electrolysis device 23. According to this configuration, it is possible to obtain an objective function setting the proportion of the amount of consumption of the green power or the amount of consumption of the green power to a desired aspect.

The water electrolysis device 23 consumes the green power. For a function including at least one of the proportion of the amount of consumption of the green power to the total amount of power consumed by the water electrolysis device 23 or the amount of green power consumed by the water electrolysis device 23, the optimization calculation unit 15 may solve a problem of maximizing the proportion of the amount of consumption of the green power or the amount of consumption of the green power as an optimization problem. According to this configuration, it is possible to obtain an operation plan maximizing the proportion of the amount of consumption of the green power or the amount of consumption of the green power.

The storage battery 22 stores the green power. The constraint condition designation unit 12 may designate the proportion of the amount of storage of the green power to the total amount of power stored in the storage battery 22 or the amount of green power stored in the storage battery 22. According to this configuration, it is possible to obtain an operation plan setting the proportion of the amount of storage of the green power or the amount of storage of the green power to a desired value.

The storage battery 22 stores the green power. The objective function designation unit 13 may set, as the objective function, a function including at least one of the proportion of the amount of storage of the green power to the total amount of power stored in the storage battery 22 or the amount of green power stored in the storage battery 22. According to this configuration, it is possible to obtain an objective function setting the proportion of the amount of storage of the green power or the amount of storage of the green power to a desired aspect.

The storage battery 22 stores the green power. For the function including at least one of the proportion of the amount of storage of the green power to the total amount of power stored in the storage battery 22 or the amount of green power stored in the storage battery 22, the optimization calculation unit 15 may solve a problem of maximizing the proportion of the amount of storage of the green power or the amount of storage of the green power as an optimization problem. According to this configuration, it is possible to obtain an operation plan maximizing the proportion of the amount of storage of the green power or the amount of storage of the green power.

The objective function designation unit 13 designates a first objective function which is the objective function. The first objective function may set the minimization of the black power obtained from the external system 3 in order to meet the power demand of the microgrid 2 as the objective required for the microgrid 2. According to this configuration, it is possible to obtain an operation plan minimizing the black power obtained from the external system 3 in order to meet the power demand of the microgrid 2.

The objective function designation unit 13 designates a second objective function which is the objective function. The second objective function may set the maximization of a product output by the water electrolysis device 23 as a result of receiving at least the green power as the objective required for the microgrid 2. According to this configuration, it is possible to obtain an operation plan maximizing the amount of hydrogen output by the water electrolysis device 23.

The objective function designation unit 13 designates a third objective function which is the objective function. The third objective function may set, as the objective, at least one of the minimization of the cost of operating the microgrid 2, the maximization of profits from the operation of the microgrid 2, and the minimization of the amount of carbon dioxide emitted by the operation of the microgrid 2. According to this configuration, it is possible to obtain an operation plan achieving at least one of the minimization of the cost of operating the microgrid 2, the maximization of the profits from the operation of the microgrid 2, and the minimization of the amount of carbon dioxide emitted by the operation of the microgrid 2.

The objective function designation unit 13 sets the amount of emission of carbon dioxide associated with the generation of the green power using a first numerical expression. The objective function designation unit 13 may set the amount of emission of carbon dioxide associated with the generation of the black power using a second numerical expression different from the first numerical expression. According to this configuration, it is also possible to obtain an operation plan that can achieve the objective required for the microgrid 2.

The solar power generation device 21 outputs the green power based on renewable energy. According to this configuration, the green power can be used as so-called green power.

The microgrid 2 includes a water electrolysis device as the power receiving device. According to this configuration, the microgrid 2 can produce hydrogen.

The microgrid 2 includes a storage battery as the power receiving device. According to this configuration, the microgrid 2 can have the function of storing power.

The operation plan creation device 1 further includes the optimization result output unit 16 generating display information for displaying the operation plan on the basis of the operation plan. The optimization result output unit 16 displays the power supplied to the water electrolysis device 23 in an aspect in which the green power and the black power can be distinguished from each other. According to this configuration, the operation plan can be presented in an aspect in which the green power and the black power can be distinguished from each other.

First power is power not involving the emission of carbon dioxide during power generation. According to this configuration, the first power can be used as so-called green power.

Second power is power involving the emission of carbon dioxide during power generation. According to this configuration, the second power can be used as so-called black power.

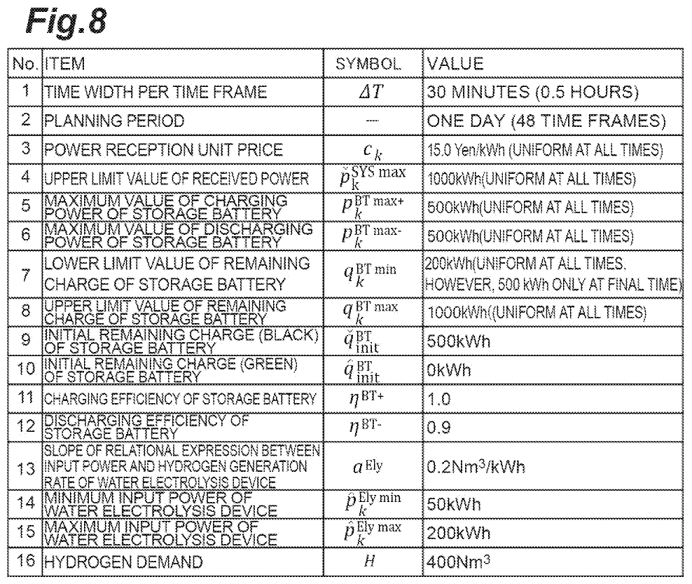

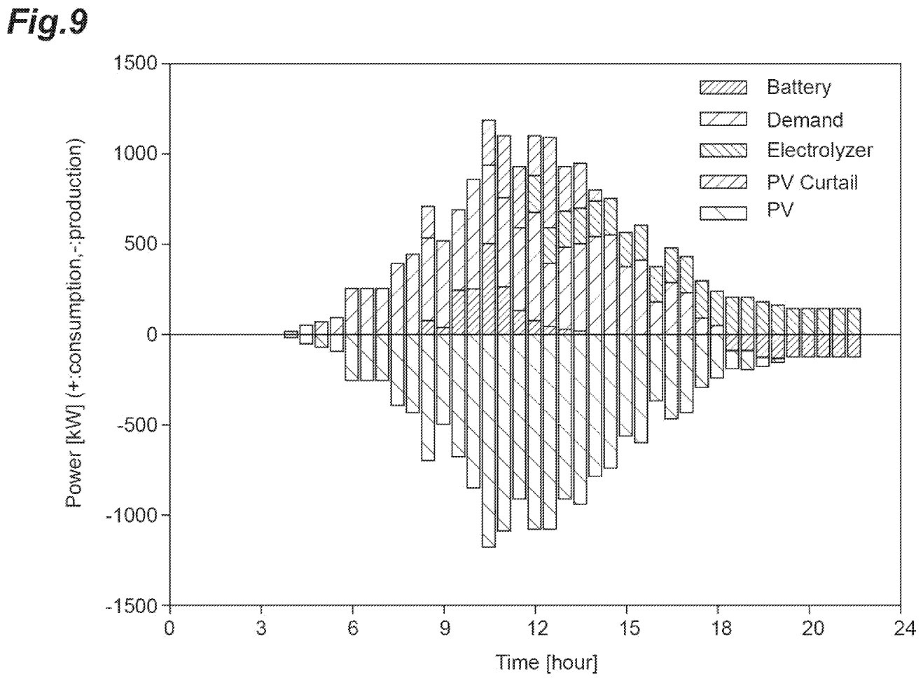

FIGS. 9 to 13 show the effects of the operation plan creation device 1, the operation plan creation method, and the operation plan creation program according to the embodiment. FIGS. 9 to 13 show the operation plans calculated under the conditions shown in FIG. 8. In addition, in the calculation example, it is assumed that the water electrolysis device 23 can be started only after 12:00. FIG. 9 shows a change in the supply and demand balance of the green power. As can be seen from FIG. 9, in the time period in which the water electrolysis device 23 is in operation, the green power necessary for hydrogen production is applied to the water electrolysis device 23. Under the conditions of the example calculation, the solar power generated after 12:00 when the water electrolysis device 23 is available is insufficient by itself to produce a given amount of hydrogen. In contrast, a plan is to charge the storage battery 22 with the power generated by solar power generation in the morning and to operate the water electrolysis device 23 using the power discharged from the storage battery 22 after the evening (from 18:00).

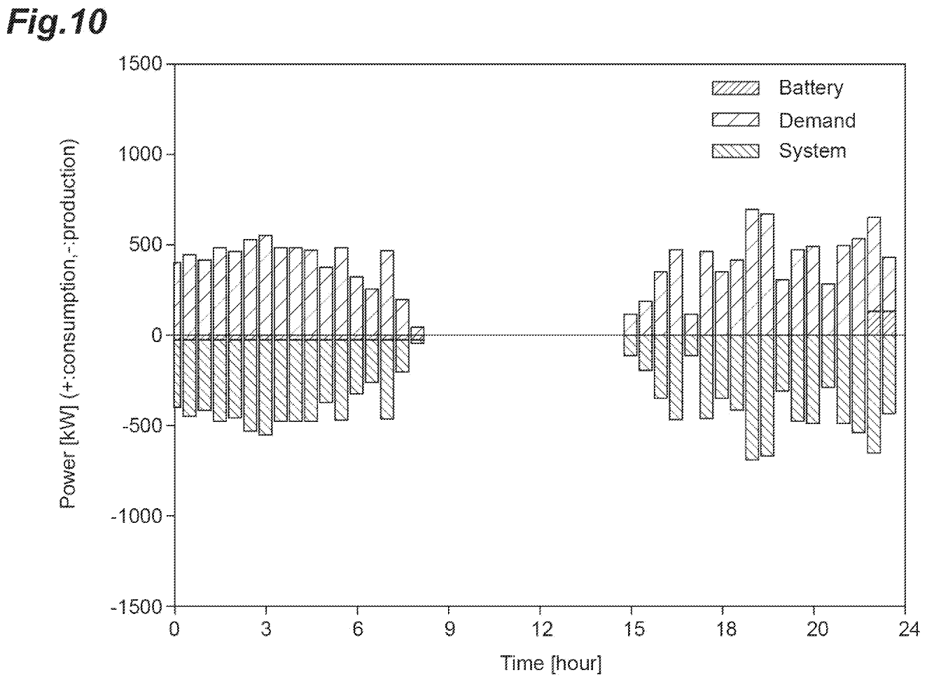

FIG. 10 shows a change in the supply and demand balance of the black power. It can be seen that the black power received from the external system 3 is used to meet the demand for power during the night when no power is generated by the solar power generation device 21.

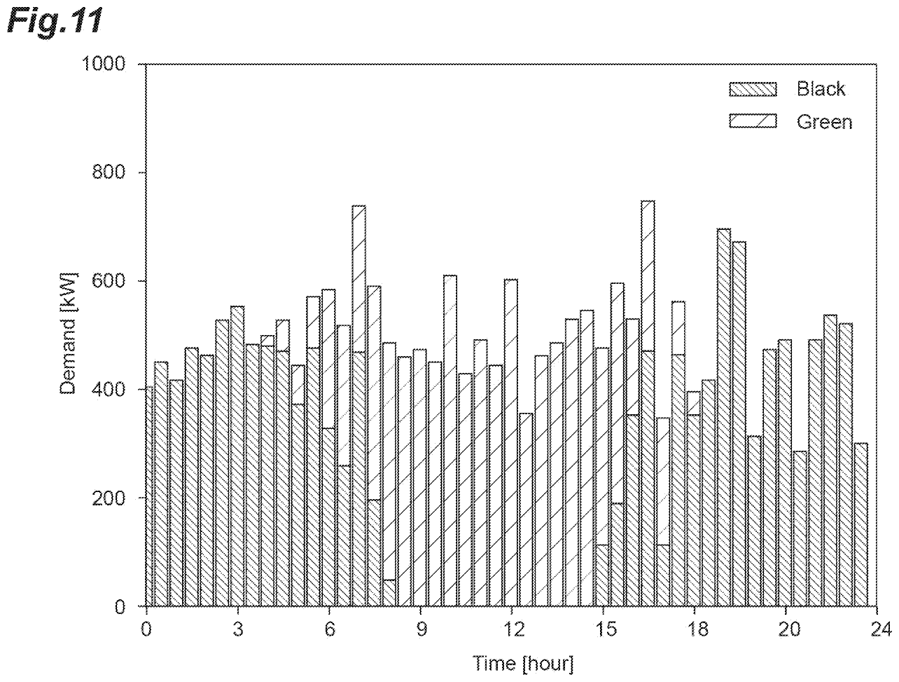

FIG. 11 shows the breakdown of the green power and the black power covering the power demand of the microgrid 2 in each time period. As described so far, it can be seen that the green power is mainly applied during the day. It can be seen that the black power is mainly applied at night.

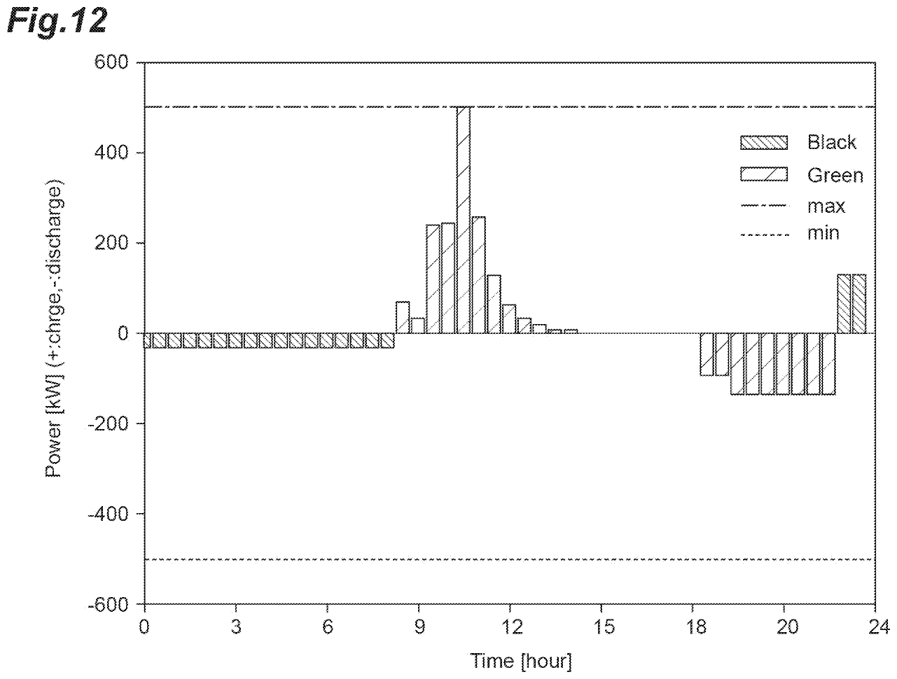

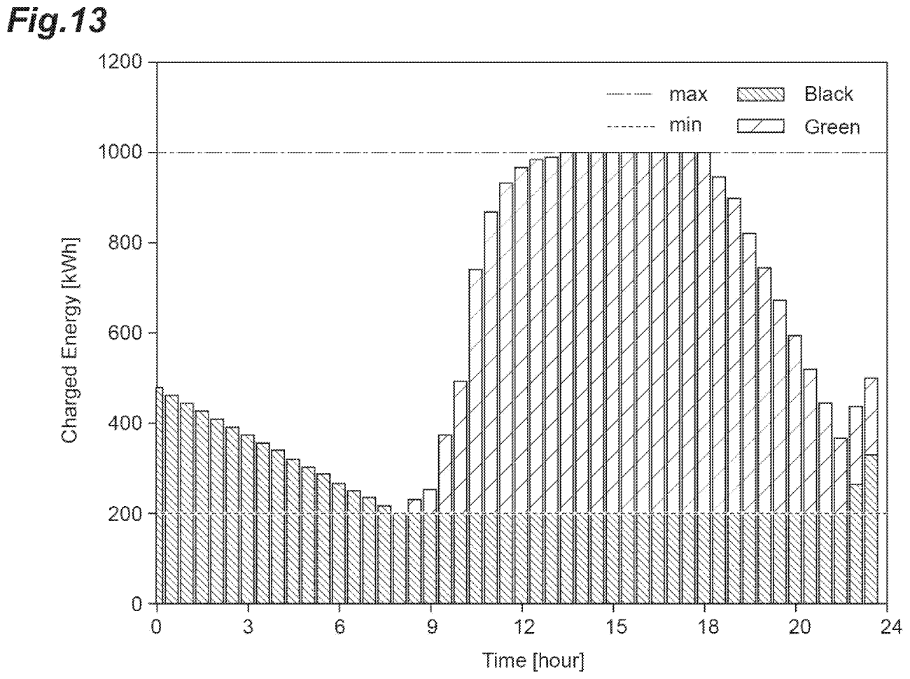

FIGS. 12 and 13 show changes in the charging and discharging power and remaining charge of the storage battery 22, respectively. It can be seen that a plan is to discharge the black power in the morning and to perform charging with the green power generated by the solar power generation device 21 in order to operate the water electrolysis device 23 using the green power after the evening. The tendency of the operation plan described above is appropriate for the objective of setting all the power applied to the water electrolysis device 23 to the green power.

The examples of the operation plan creation device 1, the operation plan creation method, and the operation plan creation program according to the present disclosure have been described above. The operation plan creation device 1, the operation plan creation method, and the operation plan creation program according to the present disclosure are not limited to the above examples and may be implemented in various forms.

The operation plan creation device 1 according to the embodiment creates an operation plan for the water electrolysis device 23 which is an example of the power receiving device. The power receiving device is not limited to the water electrolysis device 23. Since carbon-free energy has added value, there are many needs to operate devices using only the green power. For example, the power receiving device may be an electric boiler. The power receiving device may be an electric furnace melting scrap iron. The power receiving device may be an electrolytic refining/electrorefining device producing crude iron from iron ore. The power receiving device may be other chemical process devices such as methanation devices. The power receiving device may be a plastic processing device, such as a rolling device, a food processing device, a distillation device, and a heat treatment furnace such as a surface heat treatment furnace.

The operation plan created by the operation plan creation device 1 may be applied to any device other than the water electrolysis device 23 as long as it consumes power. The operation plan may be applied to, for example, an information processing device that can execute processes and stand by at any time. This is because the information processing device is desired to perform an operation of concentrating arithmetic processing in a time period in which it is desired to consume power and standing by in a case where it is not desired to consume power. The information processing device may be a computer performing Proof of Work (PoW) in the blockchain.

In the embodiment, one storage battery 22 and one water electrolysis device 23 are provided. A plurality of storage batteries 22 may be provided. A plurality of water electrolysis devices 23 may be provided. It is easy to extend the mixed integer programming problem (PG) to a plurality of devices. Even in a case where only the storage battery 22 or only the water electrolysis device 23 is used, the operation plan creation device 1, the operation plan creation method, and the operation plan creation program can be applied. In the embodiment, the operation plans for the storage battery 22 and the water electrolysis device 23 are created at the same time. However, it is not necessary to create the operation plans for the storage battery 22 and the water electrolysis device 23 at the same time. For example, a system different from the operation plan creation device 1 may create the operation plan for one of the storage battery 22 and the water electrolysis device 23, and the operation plan creation device 1 may create the operation plan for the other using the above-mentioned mathematical programming method.

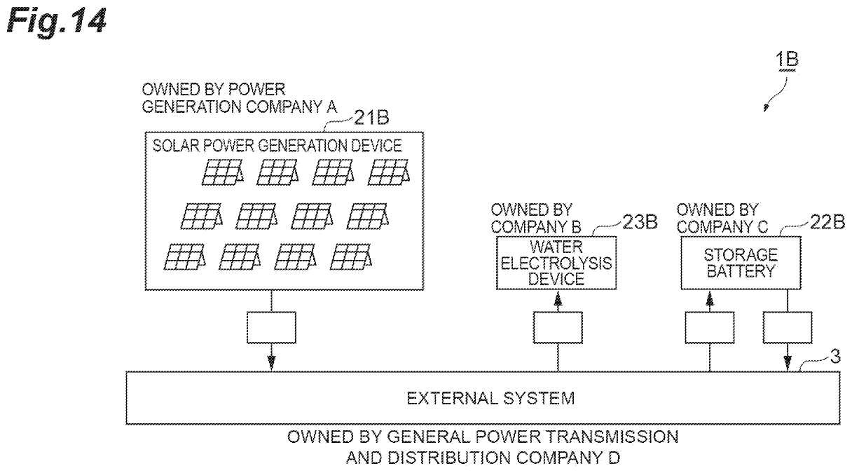

In the embodiment, as shown in FIG. 1, one microgrid 2 includes all of the solar power generation device 21 which is an example of the renewable energy generation device, the storage battery 22, and the water electrolysis device 23. However, the system to which the operation plan obtained by the operation plan creation device 1, the operation plan creation method, and the operation plan creation program is applied is not limited to the microgrid 2. For example, the operation plan can also be applied to a virtual power system in which facilities are connected to each other through the external system 3 as shown in FIG. 1. A device group having the connection form shown in FIG. 14 may be regarded as a virtual microgrid 2B, and the operation plan obtained by the operation plan creation device 1, the operation plan creation method, and the operation plan creation program may be applied to the virtual microgrid 2B. A power system 1B includes a solar power generation system 21B owned by a power generation company A, a water electrolysis device 23B owned by a company B, and a storage battery 22B owned by a company C. The solar power generation system 21B, the water electrolysis device 23B, and the storage battery 22B are connected through the external system 3. That is, the companies that own each system may be different. In this case, the contract between the companies may be a transaction through an electricity market or a bilateral transaction.

In the embodiment, the mathematical programming problem is formulated as the mixed integer programming problem (PG). However, the present disclosure is not limited thereto. The mathematical programming problem may be formulated as, for example, a nonlinear programming problem. For example, a genetic algorithm (GA) or a particle swarm optimization (PSO) may be used as an algorithm for solving the nonlinear programming problem. Since it is known that it is difficult to find a global optimal solution for the nonlinear programming problem, a suboptimal solution (approximate solution) may be found.

In the embodiment, a relational expression between a hydrogen production flow rate and power consumption is a linear expression. However, a higher-order relational expression may be used. The relationship between the hydrogen production flow rate and the power consumption may be represented by a nonlinear map.

In the embodiment, hydrogen storage, such as a high-pressure hydrogen tank, is not considered. It is also possible to create an operation plan under constraints on the upper and lower limits of the tank in consideration of tank capacity.

Calculation resources do not need to be local. The calculation resources may be in the cloud.

A portion or all of the created operation plan may be provided as an instruction or advice to the operator by monitor display, the turn-on of a lamp, alarm sound, e-mail notification, and the like. The operation plan creation device 1 may automatically perform the operation of the water electrolysis device 23 or the charging and discharging of the storage battery 22 at the corresponding time on the basis of the operation plan. The operation plan creation device 1 may operate only one of the devices. The use of the operation plan is not limited to the operation of these devices. The operation plan may be used to bid on the electricity market or to apply for self-consignment of power. The operation plan may be used for demand response commands and response determination for avoiding power shortage situations. The operation plan may be used to transmit a schedule for the amount of hydrogen produced to another system managing the amount of hydrogen produced.

In the embodiment, the system exchanging energy with the outside is conveniently called the “microgrid 2”. The aspect of the system exchanging energy with the outside is not necessarily limited to a single factory or workplace. For example, the system exchanging energy with the outside may be a factory complex which is a bundle of a plurality of factories.

The operation plan creation device, the operation plan creation method, and the operation plan creation program include the following configurations.

[1] According to the present disclosure, there is provided “an operation plan creation device applied to a power system consuming first power obtained from a first energy source and second power obtained from a second energy source different from the first energy source, the power system including a power receiving device, the operation plan creation device including: a predicted value designation unit designating a predicted value of power to be supplied as the first power from the first energy source to the power system; a constraint condition designation unit designating a constraint condition that includes a term indicating the first power and a term indicating the second power and separately treats the first power and the second power for an operation of the power system; an objective function designation unit designating an objective function formulating an objective required for the power system; and an optimization calculation unit solving a problem defined by the predicted value of the power to be supplied, the constraint condition, and the objective function to obtain an operation plan for the power system”.

[2] According to the present disclosure, in “the operation plan creation device according to [1], the constraint condition designation unit designates a first constraint condition which is the constraint condition, and the first constraint condition is that only the first power is set as the power to be supplied to the power receiving device”.

[3] According to the present disclosure, in “the operation plan creation device according to [1], the constraint condition designation unit designates a second constraint condition which is the constraint condition, and the second constraint condition is that a proportion of the first power to a total amount of power supplied to the power receiving device is designated”.

[4] According to the present disclosure, in “the operation plan creation device according to any one of [1] to [3], the power receiving device consumes the first power, and the constraint condition designation unit designates a proportion of an amount of consumption of the first power to a total amount of power consumed by the power receiving device or the amount of the first power consumed by the power receiving device”.

[5] According to the present disclosure, in “the operation plan creation device according to any one of [1] to [3], the power receiving device consumes the first power, and the objective function designation unit sets, as the objective function, a function including at least one of a proportion of an amount of consumption of the first power to a total amount of power consumed by the power receiving device or the amount of the first power consumed by the power receiving device”.

[6] According to the present disclosure, in “the operation plan creation device according to any one of [1] to [3], the power receiving device consumes the first power, and, for a function including at least one of a proportion of an amount of consumption of the first power to a total amount of power consumed by the power receiving device or the amount of the first power consumed by the power receiving device, the optimization calculation unit solves a problem of maximizing the proportion of the amount of consumption of the first power or the amount of consumption of the first power as an optimization problem”.

[7] According to the present disclosure, in “the operation plan creation device according to any one of [1] to [3], the power receiving device stores the first power, and the constraint condition designation unit designates a proportion of an amount of storage of the first power to a total amount of power stored in the power receiving device or the amount of the first power stored in the power receiving device”.

[8] According to the present disclosure, in “the operation plan creation device according to any one of [1] to [3], the power receiving device stores the first power, and the objective function designation unit sets, as the objective function, a function including at least one of a proportion of an amount of storage of the first power to a total amount of power stored in the power receiving device or the amount of the first power stored in the power receiving device”.

[9] According to the present disclosure, in “the operation plan creation device according to any one of [1] to [3], the power receiving device stores the first power, and, for a function including at least one of a proportion of an amount of storage of the first power to a total amount of power stored in the power receiving device or the amount of the first power stored in the power receiving device, the optimization calculation unit solves a problem of maximizing the proportion of the amount of storage of the first power or the amount of storage of the first power as an optimization problem”.

[10] According to the present disclosure, in “the operation plan creation device according to any one of [1] to [3], the objective function designation unit designates a first objective function which is the objective function, and the first objective function sets minimization of the second power obtained from the second energy source as the objective required for the power system in order to meet a power demand of the power system”.

[11] According to the present disclosure, in “the operation plan creation device according to any one of [1] to [3], the objective function designation unit designates a second objective function which is the objective function, and the second objective function sets maximization of a product output by the power receiving device as a result of receiving at least the first power as the objective required for the power system”.

[12] According to the present disclosure, in “the operation plan creation device according to any one of [1] to [3], the objective function designation unit designates a third objective function which is the objective function, and the third objective function sets, as the objective, at least one of minimization of a cost of operating the power system, maximization of profits from the operation of the power system, and minimization of an amount of carbon dioxide emitted by the operation of the power system”.

[13] According to the present disclosure, in “the operation plan creation device according to any one of [1] to [12], the objective function designation unit sets an amount of emission of carbon dioxide associated with generation of the first power using a first numerical expression and sets an amount of emission of carbon dioxide associated with generation of the second power using a second numerical expression different from the first numerical expression”.

[14] According to the present disclosure, in “the operation plan creation device according to any one of [1] to [13], the first energy source outputs the first power based on renewable energy”.

[15] According to the present disclosure, in “the operation plan creation device according to any one of [1] to [14], the power system includes a water electrolysis device as the power receiving device”.

[16] According to the present disclosure, in “the operation plan creation device according to any one of [1] to [15], the power system includes a storage battery as the power receiving device”.

[17] According to the present disclosure, “the operation plan creation device according to any one of [1] to further includes an optimization result output unit generating display information for displaying the operation plan on the basis of the operation plan, in which the optimization result output unit displays the power supplied to the power receiving device in an aspect in which the first power and the second power are distinguishable”.

[18] According to the present disclosure, in “the operation plan creation device according to any one of [1] to [17], the first power is power not involving emission of carbon dioxide during power generation”.

[19] According to the present disclosure, in “the operation plan creation device according to any one of [1] to [18], the second power is power involving emission of carbon dioxide during power generation”.

[20] According to the present disclosure, there is provided “an operation plan creation method applied to a power system consuming first power obtained from a first energy source and second power obtained from a second energy source different from the first energy source, the power system including a power receiving device, the operation plan creation method including: designating a predicted value of power to be supplied as the first power from the first energy source to the power system; designating a constraint condition that includes a term indicating the first power and a term indicating the second power and separately treats the first power and the second power for an operation of the power system; designating an objective function formulating an objective required for the power system; and solving a problem defined by the predicted value of the power to be supplied, the constraint condition, and the objective function to obtain an operation plan for the power system”.

[21] According to the present disclosure, there is provided “an operation plan creation program applied to a power system consuming first power obtained from a first energy source and second power obtained from a second energy source different from the first energy source, the power system including a power receiving device, the operation plan creation program causing a computer to execute: designating a predicted value of power to be supplied as the first power from the first energy source to the power system; designating a constraint condition that includes a term indicating the first power and a term indicating the second power and separately treats the first power and the second power for an operation of the power system; designating an objective function formulating an objective required for the power system; and solving a problem defined by the predicted value of the power to be supplied, the constraint condition, and the objective function to obtain an operation plan for the power system”.

[22] According to the present disclosure, there is provided “a method for producing hydrogen using a hydrogen production system consuming first power obtained from a first energy source and second power obtained from a second energy source different from the first energy source, the hydrogen production system including at least a hydrogen production unit obtaining hydrogen using the first power, the method including: designating a predicted value of power to be supplied as the first power from the first energy source to the hydrogen production unit; designating a constraint condition that includes a term indicating the first power and a term indicating the second power and separately treats the first power and the second power for an operation of the hydrogen production unit; designating an objective function formulating an objective required for the hydrogen production unit; and solving a problem defined by the predicted value of the power to be supplied, the constraint condition, and the objective function to obtain an operation plan for the hydrogen production unit”.

### OTHERS

According to the operation plan creation device 1, the operation plan creation method, and the operation plan creation program of the present disclosure, the development of a technique using hydrogen or hydrides derived from renewable energy as a replacement for fossil fuels is promoted in order to reduce CO₂ emissions. The application of the operation plan creation device 1, the operation plan creation method, and the operation plan creation program according to the present disclosure makes it possible to suppress the emission of unnecessary CO₂ generated during hydrogen production. The operation plan creation device 1, the operation plan creation method, and the operation plan creation program according to the present disclosure contribute to Goal 13 of the Sustainable Development Goals (SDGs) led by the United Nations.
Goal 13: “Take urgent action to combat climate change and its impacts.”

What is claimed is:

1. An operation plan creation device applied to a power system consuming first power obtained from a first energy source and second power obtained from a second energy source different from the first energy source, the power system including a power receiving device, the operation plan creation device comprising:
a predicted value designation unit designating a predicted value of power to be supplied as the first power from the first energy source to the power system;
a constraint condition designation unit designating a constraint condition that includes a term indicating the first power and a term indicating the second power and separately treats the first power and the second power for an operation of the power system;
an objective function designation unit designating an objective function formulating an objective required for the power system; and
an optimization calculation unit solving a problem defined by the predicted value of the power to be supplied, the constraint condition, and the objective function to obtain an operation plan for the power system.

2. The operation plan creation device according to claim 1,
wherein the constraint condition designation unit designates a first constraint condition which is the constraint condition, and
the first constraint condition is that only the first power is set as the power to be supplied to the power receiving device.

3. The operation plan creation device according to claim 1,
wherein the constraint condition designation unit designates a second constraint condition which is the constraint condition, and
the second constraint condition is that a proportion of the first power to a total amount of power supplied to the power receiving device is designated.

4. The operation plan creation device according to claim 1,
wherein the power receiving device consumes the first power, and
the constraint condition designation unit designates a proportion of an amount of consumption of the first power to a total amount of power consumed by the power receiving device or the amount of the first power consumed by the power receiving device.

5. The operation plan creation device according to claim 1,
wherein the power receiving device consumes the first power, and
the objective function designation unit sets, as the objective function, a function including at least one of a proportion of an amount of consumption of the first power to a total amount of power consumed by the power receiving device or the amount of the first power consumed by the power receiving device.

6. The operation plan creation device according to claim 1,
wherein the power receiving device consumes the first power, and
for a function including at least one of a proportion of an amount of consumption of the first power to a total amount of power consumed by the power receiving device or the amount of the first power consumed by the power receiving device, the optimization calculation unit solves a problem of maximizing the proportion of the amount of consumption of the first power or the amount of consumption of the first power as an optimization problem.

7. The operation plan creation device according to claim 1,
wherein the power receiving device stores the first power, and
the constraint condition designation unit designates a proportion of an amount of storage of the first power to a total amount of power stored in the power receiving device or the amount of the first power stored in the power receiving device.

8. The operation plan creation device according to claim 1,
wherein the power receiving device stores the first power, and
the objective function designation unit sets, as the objective function, a function including at least one of a proportion of an amount of storage of the first power to a total amount of power stored in the power receiving device or the amount of the first power stored in the power receiving device.

9. The operation plan creation device according to claim 1,
wherein the power receiving device stores the first power, and
for a function including at least one of a proportion of an amount of storage of the first power to a total amount of power stored in the power receiving device or the amount of the first power stored in the power receiving device, the optimization calculation unit solves a problem of maximizing the proportion of the amount of storage of the first power or the amount of storage of the first power as an optimization problem.

10. The operation plan creation device according to claim 1,
wherein the objective function designation unit designates a first objective function which is the objective function, and
the first objective function sets minimization of the second power obtained from the second energy source as the objective required for the power system in order to meet a power demand of the power system.

11. The operation plan creation device according to claim 1,
wherein the objective function designation unit designates a second objective function which is the objective function, and
the second objective function sets maximization of a product output by the power receiving device as a result of receiving at least the first power as the objective required for the power system.

12. The operation plan creation device according to claim 1,
wherein the objective function designation unit designates a third objective function which is the objective function, and
the third objective function sets, as the objective, at least one of minimization of a cost of operating the power system, maximization of profits from the operation of the power system, and minimization of an amount of carbon dioxide emitted by the operation of the power system.

13. The operation plan creation device according to claim 1,
wherein the objective function designation unit sets an amount of emission of carbon dioxide associated with generation of the first power using a first numerical expression and sets an amount of emission of carbon dioxide associated with generation of the second power using a second numerical expression different from the first numerical expression.

14. The operation plan creation device according to claim 1,
wherein the first energy source outputs the first power based on renewable energy.

15. The operation plan creation device according to claim 1,
wherein the power system includes a water electrolysis device as the power receiving device.

16. The operation plan creation device according to claim 1,
wherein the power system includes a storage battery as the power receiving device.

17. The operation plan creation device according to claim 1, further comprising:
an optimization result output unit generating display information for displaying the operation plan on the basis of the operation plan,
wherein the optimization result output unit displays the power supplied to the power receiving device in an aspect in which the first power and the second power are distinguishable.

18. The operation plan creation device according to claim 1,
wherein the first power is power not involving emission of carbon dioxide during power generation.

19. The operation plan creation device according to claim 1,
wherein the second power is power involving emission of carbon dioxide during power generation.

20. An operation plan creation method applied to a power system consuming first power obtained from a first energy source and second power obtained from a second energy source different from the first energy source, the power system including a power receiving device, the operation plan creation method comprising:
designating a predicted value of power to be supplied as the first power from the first energy source to the power system;
designating a constraint condition that includes a term indicating the first power and a term indicating the second power and separately treats the first power and the second power for an operation of the power system;
designating an objective function formulating an objective required for the power system; and
solving a problem defined by the predicted value of the power to be supplied, the constraint condition, and the objective function to obtain an operation plan for the power system.

21. An operation plan creation program applied to a power system consuming first power obtained from a first energy source and second power obtained from a second energy source different from the first energy source, the power system including a power receiving device, the operation plan creation program causing a computer to execute:
designating a predicted value of power to be supplied as the first power from the first energy source to the power system;
designating a constraint condition that includes a term indicating the first power and a term indicating the second power and separately treats the first power and the second power for an operation of the power system;
designating an objective function formulating an objective required for the power system; and
solving a problem defined by the predicted value of the power to be supplied, the constraint condition, and the objective function to obtain an operation plan for the power system.

22. A method for producing hydrogen including obtaining an operation plan applied to a hydrogen production system consuming first power obtained from a first energy source and second power obtained from a second energy source different from the first energy source by executing the operation plan creation method according to claim 20,
wherein the power system according to claim 20 is the hydrogen production system including at least a hydrogen production unit obtaining hydrogen using the first power,
the constraint condition according to claim 20 relates to an operation of the hydrogen production unit, and
the objective function according to claim 20 is a formulation of an objective required for the hydrogen production unit.
